(19) United States
(12) Patent Application Publication
(10) Pub. No.: US 2022/0324119 A1
(43) Pub. Date: Oct. 13, 2022

(54) FOOD PREPARATION SYSTEM

(71) Applicant: Nala Robotics, Inc., Arlington Heights, IL (US)

(72) Inventors: Vijay Kodali, Palatine, IL (US); Ajay Kumar Sunkara, South Barrington, IL (US)

(21) Appl. No.: 17/718,193

(22) Filed: Apr. 11, 2022

Related U.S. Application Data
(60) Provisional application No. 63/173,606, filed on Apr. 12, 2021.

(51) Int. Cl. B25J 11/00; B25J 9/00; B25J 9/16; A47J 44/00; A21B 1/42; A21B 3/07

(52) U.S. Cl. CPC B25J 11/0045; B25J 9/0093; B25J 9/0096; B25J 9/1679; A47J 44/00; A21B 1/42; A21B 3/07

(57) ABSTRACT

A food preparation system arranged in a kitchen includes a gantry fixed with the kitchen, at least one robot arm having an end effector supported on a base in the kitchen, where the base is movably mounted on the gantry, defining a reaching distance of the robot from the end effector to the base, along a travel path of the base on the gantry, a storage container arranged in the kitchen, within the reaching distance of the at least one robot arm, and configured for storing a food item, at least one ingredient distribution device arranged in the kitchen, within the reaching distance of the at least one robot arm, and configured for dispensing at least one ingredient on the food item, and an oven arranged in the kitchen, within the reaching distance of the at least one robot arm, and configured for baking the food item.

### BACKGROUND

Known methods and devices for automated industrial serial production of pizzas and flattened dough, often feature the following working phases: preparation of dough including rising of the dough; extrusion of the dough for the purpose of forming a coherent mass; cutting of a dough strand into dough portions; processing portions of the dough into flat, round patties with spices and garnishes; baking and packaging the dough for consumption within an expiry date or for deep-freezing. In order to speed up preparation of the dough, pretreated dried granules are used in some processes, and the seasoning, garnishing and/or coloring is carried out on a minimum number of pizzas of a same type, namely during a passage of the pizzas which are on a conveyor belt at a short distance from one another and then baked in a tunnel oven. Some processes bake the pizza in their own baking tins to allow egg to be pushed into the oven. Systems are also known in which flattened dough is present in a prefabricated and pre-cooked manner, and is garnished and baked or heated as a result of removal from a cooling compartment.

The technical features of these known devices and processes do not make it possible to produce pizzas in one-off production according to individual orders as a result of selection from a list. The devices for carrying out such a task require a lot of space to operate, and further require conveyor belts to convey product from one device to the next device. Accordingly, there is a want for an automated pizza process and system configured to automatically prepare and rapidly provide individual pizzas.

### BRIEF DESCRIPTION

According to one aspect, a food preparation system arranged in a kitchen includes a gantry, at least one robot arm, a storage container, at least one ingredient distribution device, and an oven. The gantry is fixed with the kitchen. The at least one robot arm has an end effector supported on a base in the kitchen, wherein the base is movably mounted on the gantry, defining a reaching distance of the robot from the end effector to the base, along a travel path of the base on the gantry. The storage container is arranged in the kitchen, within the reaching distance of the at least one robot arm, and configured for storing a food item. The at least one ingredient distribution device is arranged in the kitchen, within the reaching distance of the at least one robot arm, and configured for dispensing at least one ingredient on the food item. The oven arranged in the kitchen, within the reaching distance of the at least one robot arm, and configured for baking the food item.

According to another aspect, a food preparation system arranged in a kitchen includes at least one robot arm, a storage container, at least one ingredient distribution device, and an oven. The at least one robot arm has an end effector supported on a base in the kitchen, defining a reaching distance from the end effector to the base. The storage container is arranged in the kitchen, within the reaching distance of the at least one robot arm, and configured for storing a food item. The at least one ingredient distribution device is arranged in the kitchen, within the reaching distance of the at least one robot arm, and configured for dispensing at least one ingredient on the food item. The oven is arranged in the kitchen, within the reaching distance of the at least one robot arm, and configured for baking the food item.

According to another aspect, a food preparation system arranged in a kitchen includes a conveyor, at least one robot arm, a storage container, a press, a sauce distribution device, a toppings distribution device, an oven, and a cutting tool. The at least one robot arm has an end effector supported on a base in the kitchen, defining a reaching distance of the at least one robot arm. The storage container is arranged in the kitchen, configured for storing dough, and operatively connected to the conveyor for dispensing the dough onto the conveyor. The press is arranged in the kitchen, within the reaching distance of the at least one robot arm, where the press is configured for pressing the dough to form a crust as flattened dough, and operably connected with the conveyor for receiving the dough from the conveyor. The sauce distribution device is arranged in the kitchen, within the reaching distance of the at least one robot arm, and configured for dispensing sauce on the crust. The toppings distribution device is arranged in the kitchen, within the reaching distance of the at least one robot arm, and configured for dispensing toppings on the crust. The oven is arranged in the kitchen, within the reaching distance of the at least one robot arm, and configured for baking the crust. The cutting tool is arranged in the kitchen, within the reaching distance of the at least one robot arm, and configured for cutting the crust. The storage container, the press, the sauce distribution device, the toppings distribution device, the oven, and the cutting tool are arranged in a production line with the storage container and the press located in a dough preparation area, the sauce distribution device and the toppings distribution device located in an ingredients assembly area, and the oven and the cutting tool located in a cooking area. The ingredients assembly area is interposed between and separates the dough preparation area and the cooking area along the production line.

### BRIEF DESCRIPTION OF THE DRAWINGS

FIG. 1 depicts a schematic view of an automated kitchen, according to one embodiment of the present disclosure.

FIG. 2 depicts a schematic view of an automated kitchen, according to another embodiment.

FIG. 3 depicts a schematic view of an automated kitchen, according to another embodiment.

FIG. 4 depicts a schematic view of an automated kitchen, according to another embodiment.

FIG. 5 depicts a schematic view of an automated kitchen, according to another embodiment.

FIG. 6 depicts a schematic view of an automated kitchen, according to another embodiment.

FIG. 7 depicts a top perspective view of the exemplary automated kitchen.

FIG. 8 depicts a side perspective view of the exemplary automated kitchen.

FIG. 9 depicts another side perspective view of the exemplary automated kitchen.

FIG. 10 depicts an enlarged top perspective view of the exemplary automated kitchen.

FIG. 11 depicts a perspective view of the exemplary automated kitchen.

FIG. 12 depicts a perspective view of an exemplary automated kitchen according to another embodiment.

FIG. 13 depicts a top view of the exemplary automated kitchen of FIG. 12.

FIG. 14 depicts a front view of the exemplary automated kitchen of FIG. 12.

FIG. 15 depicts a side view of the exemplary automated kitchen of FIG. 12.

FIG. 16 depicts an exemplary pizza making process carried out by the exemplary automated kitchens.

FIG. 17 is an illustration of an example computing environment where one or more of the provisions set forth herein are implemented, according to one aspect.

### DETAILED DESCRIPTION

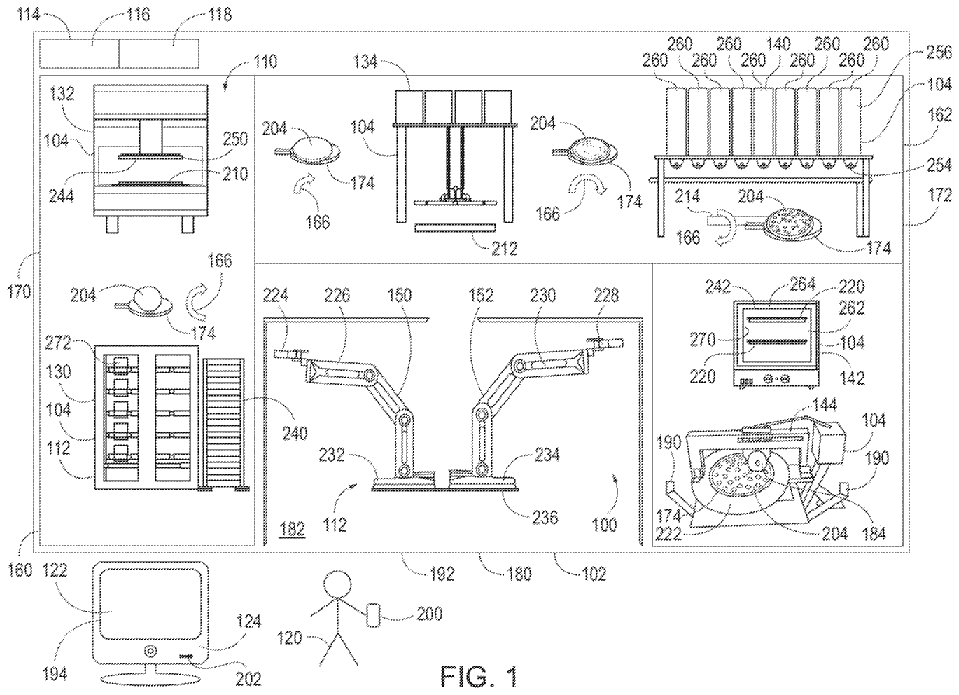

It should, of course, be understood that the description and drawings herein are merely illustrative and that various modifications and changes can be made in the structures disclosed without departing from the present disclosure. Referring now to the drawings, wherein like numerals refer to like parts throughout the several views, FIG. 1 depicts a general arrangement of a food preparation system 100 in a kitchen 102 in a schematic view.

The kitchen 102, as depicted, is configured for preparing a variety of pizzas and similar food items by storing ingredients for the food items at various food stations 104 configured for preparing the ingredients, and connecting the food stations 104 in a production line 110 with a transport mechanism 112 configured transport the ingredients between the food stations 104 and distribute prepared food items to corresponding users. The food stations 104 and transport mechanism 112 are actuated by a control system 114 in accordance with programmed recipes selected by a user 120 from a menu 122 displayed at a user terminal 124. The control system 114 includes a processor 116 and a memory 118, where the processor 116 is configured to execute programmed instructions stored in the memory 118 based on a food item selection by the user 120, actuating the food stations 104 and transport mechanism 112 in accordance with fulfilling the order on the production line 110. With this construction, the kitchen 102 is fully automated for preparing a predetermined variety of food items, providing improved consistency in taste, texture, flavor, softness and visual appeal of the food items prepared.

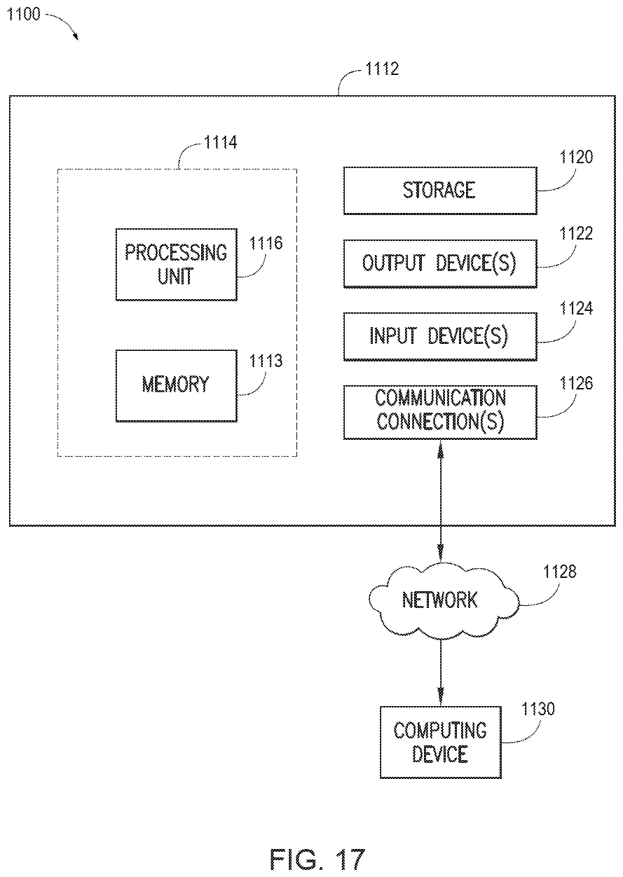

The food stations 104 are arranged in the kitchen 102 around the transport mechanism such that the food preparation system 100 is a self-contained, automatic, self-service, unattended, food preparation apparatus with cooking equipment and corresponding programmed methods to automatically prepare, cook, and dispense pizza and similar food items from the kitchen 102 based on instructions from the control system 114. The food preparation system can be fully automatic from receiving an order for a food item from the user 120, via a network 1028, shown in FIG. 17, to dispensing the ordered food item to the user 120 without requiring personnel to operate any equipment the kitchen 102.

As shown in FIG. 1, the food stations 104 include a storage container 130, a press 132, a sauce distribution device 134, a toppings distribution device 140, an oven 142, and a packaging station 144 arranged in the kitchen 102 within a reaching distance of at least one of a first pneumatic arm 150 and a second pneumatic arm 152. The storage container 130, the press 132, the sauce distribution device 134, the toppings distribution device 140, the oven 142, and the packaging station 144 are arranged in a production line 110 around the first pneumatic arm 150 and the second pneumatic arm 152.

The storage container 130 and the press 132 are located in a dough preparation area 160 of the production line 110. The sauce distribution device 134 and the toppings distribution device 140 are each an ingredient distribution device configured for dispensing at least one ingredient, such as sauce and toppings, on the crust 204. The sauce distribution device 134 and the toppings distribution device 140 are located in an ingredients assembly area 162 of the production line 110. The oven 142 and the packaging station 144 are located in a cooking area 164 of the production line 110. The ingredients assembly area 162 is interposed between and separates the dough preparation area 160 and the cooking area 164 along the production line 110, organizing the stations in the kitchen 102 in a general direction of food preparation from the storage container 130 to the packaging station 144 indicated by arrows 166. More specifically, the press 132, the sauce distribution device 134, the toppings distribution device 140, the oven 142, and the packaging station 144 are arranged in that order along the production line 110 for a consistent direction of food preparation about the kitchen 102 from the storage container 130 to the packaging station 144.

The kitchen devices, including the components of the food preparation system 100 such as the press 132, the sauce distribution device 134, the toppings distribution device 140, the oven 142, the packaging station 144, a first pneumatic arm 150 and a second pneumatic arm 152, exchange data with the control system 114. For example, an apparatus 1112, shown in FIG. 17, may be configured to implement one aspect of the control system. In one embodiment, the communication interface 1126 may exchange data and/or transmit messages with the any of the kitchen devices of food preparation system 100. The kitchen devices and the control system 114 may communicate with electronic communication devices, such as a transceiver. For example, the press 132, the sauce distribution device 134, the toppings distribution device 140, the oven 142, the packaging station 144, a first pneumatic arm 150 and a second pneumatic arm 152 may include transceivers or other communication hardware and protocols. For example, a transceiver (not shown) may exchange data with the press 132 via a remote transceiver of the press 132.

In some embodiments, the control system 114 and the kitchen devices may also exchange data over remote networks by utilizing a wireless network antenna, and/or the network 1128, or other wireless network connections. As mentioned above, in some embodiments, data transmission may be executed at and/or with other infrastructures and servers. For example, the communication interface 1126 may transmit and receive information, such as the recipe, the menu 122, and instructions to control one or more of the kitchen devices, among others, over the network 1128. While the control system 114 is described with respect to the system 1100, any of the kitchen devices may include the system 1100. For example, the press 132 may include a processor/processing unit 1116, a memory 1118, a storage 1120, output device(s) 1122, input device(s) 1124, or communications connection 1126 for communicating via the network 1128 to the control system 114.

With continued reference to FIG. 1, the storage container 130, the press 132, and the sauce distribution device 134 are arranged within a reaching distance of the first pneumatic arm 150, and the sauce distribution device 134, the toppings distribution device 140, the oven 142, and the packaging station 144 are arranged with a reaching distance of the second pneumatic arm 152. The storage container 130, the press 132, and the sauce distribution device 134 are arranged around the first pneumatic arm 150 such that the production line 110 is angled around the first pneumatic arm 150, forming a first L-shape 170 around the first pneumatic arm 150. The toppings distribution device 140, the oven 142, and the packaging station 144 are arranged around the second pneumatic arm 152 such that the production line 110 is angled around the second pneumatic arm 152, forming a second L-shape 172 around the second pneumatic arm 152. The first L-shape 170 and the second L-shape 172 are connected to each other through the ingredients assembly area 162 of the production line 110, and are oriented with legs directed toward the user terminal 124.

With this construction, the first pneumatic arm 150 is configured for transporting food items between the food stations 104 at the dough preparation area 160 and the ingredients assembly area 162 of the production line 110, and the second pneumatic arm 152 is configured for transporting food items between the food stations 104 at the ingredients assembly area 162 and the cooking area 164 of the production line 110. Also, the arrangement of the food stations 104 minimizes an overall size of the kitchen 102 necessary for enclosing the food preparation system 100, and locates the cooking area 164 at a same side of the kitchen 102 as the user terminal 124.

The system also includes a transport plate 174 configured to support ingredients, including a crust 204, along the production line 110 between the storage container 130 and the packaging station 144. The transport plate 174 is configured for being maneuvered by at least one of the first pneumatic arm 150 and the second pneumatic arm 152 about the kitchen 102 with ingredients supported thereon.

The food preparation system 100 includes a wall 180 defining a closed space 182 of the kitchen 102 inaccessible to the user 120. The storage container 130, the press 132, the sauce distribution device 134, the toppings distribution device 140, the oven 142, and the packaging station 144 are arranged in the closed space 182, inaccessible to the user 120. The packaging station 144 includes a cutting tool 184 and boxing arms 190 configured to cut, package, and dispense food items through the wall 180 for access by the user 120.

The food preparation system 100 includes the user terminal 124 arranged along the wall 180 with the packaging station 144, outside the closed space 182 and accessible by the user 120. The user terminal 124 is configured for receiving an order for a food item from the user 120 and transmitting the order to the food preparation system 100 for execution in the kitchen 102. The wall 180 defines a window 192 interposed between the user terminal 124 and the packaging station 144 along the wall 180 such that as the user 120 travels from the user terminal 124 to the packaging station 144, the user 120 travels along the window 192. Each of the storage container 130, the press 132, the sauce distribution device 134, the toppings distribution device 140, the oven 142, and the packaging station 144 are visible in the closed space 182 to the user 120 from behind the window 192.

As shown in FIG. 1, the press 132, the sauce distribution device 134, and the toppings distribution device 140 are arranged at a side of the first pneumatic arm 150 and the second pneumatic arm 152 opposite the window 192. With this configuration, the food preparation system 100 may be visually inspected from behind the window 192 with a direct line of sight to the first pneumatic arm 150 and the second pneumatic arm 152 interacting with the food stations 104, outside the closed space 182, while the food preparation system 100 prepares food items.

Customer service can be accomplished by the food preparation system 100 through the user terminal 124 with a monitor 194 that visually and electronically displays colored representations of various size pizzas, different pizza toppings and ingredients, and corresponding prices as items in the menu 122. In this manner, the user terminal 124 provides a person-to-machine interface which displays the pizza sizes and topping choices, and is configured to receive an order from the user 120 corresponding with the displayed menu items. The food preparation system may additionally or alternatively accomplish customer service through a computer or mobile device 200 controlled by the user 120, where the mobile device 200 is configured to communicate with the food preparation system 100 over a communication network.

The monitor 194 optionally includes a touch screen that operates through sensors, including a pressure-sensitive sensor and a heat-sensitive sensor which enable the food preparation system to detect and sense a finger of a customer selecting food items in an order. The sensors are activated by manual engagement of the finger of the user 120 to generate electrical impulses. The monitor 194 optionally includes a flat panel display that can be connected to analog or digital circuitry, and helps provide protection from dust, particulates, moisture, and minor vandalism. The touch screen in the monitor 194 can provide reliability and flexibility without push buttons, pull knobs, and levers. Alternatively, the monitor 194 may be operated by the user 120 with buttons 202 provided on the user terminal 124. The monitor 194 can also display the status of food items being assembled, prepared and cooked in the kitchen 102.

As shown in FIG. 1, upon ordering, selection, and payment by the user 120, a crust 204 is dispensed from the storage container 130 as a dough ball for being transported about the kitchen 102 by the first pneumatic arm 150 and the second pneumatic arm 152. The storage container 130 is a refrigerator configured to store and selectively dispense the crust 204 as dough balls to the kitchen 102. While the depicted crust 204 is stored in the storage container 130 for use by the kitchen 102, the crust 204 can be pre-made, or rolled and cut on site from pre-made dough, or mixed and formed from various scratch ingredients without departing from the scope of the present disclosure.

The first pneumatic arm 150 and the second pneumatic arm 152 can maneuver the crust 204 with respect to an indexing table having an x-y axis or x-y translator to slide and/or rotate the crust 204 about the kitchen 102. The press 132 includes a first indexing table 210, the sauce distribution device 134 includes a second indexing table 212, the toppings distribution device 140 includes a third indexing table 214, the oven 142 includes a fourth indexing table 220, and the packaging station 144 includes a fifth indexing table 222. The first pneumatic arm 150 is configured for maneuvering the crust 204 about the kitchen 102 with respect to the first indexing table 210, the second indexing table 212, and the third indexing table 214. The second pneumatic arm 152 is configured for maneuvering the crust 204 about the kitchen 102 with respect to the fourth indexing table 220, and the fifth indexing table 222.

The first pneumatic arm 150 and the second pneumatic arm 152 include similar features and function in a similar manner as each other, and are configured to cooperatively transport food items along the production line 110 from the storage container 130 toward the packaging station 144. The first pneumatic arm 150 and the second pneumatic arm 152 are each a mechanical robotic arm configured to carry and maneuver the crust 204 about the kitchen 102 and between the food stations 104.

As shown in FIG. 1, the first pneumatic arm 150 includes a first end effector 224 fixed with a first distal end portion 226 of the first pneumatic arm 150 and configured for engaging with and moving the transport plate 174 between the storage container 130, the press 132, and the sauce distribution device 134. The second pneumatic arm 152 includes a second end effector 228 fixed with a second distal end portion 230 of the second pneumatic arm 152 and configured for engaging with and moving the transport plate 174 between the sauce distribution device 134, the toppings distribution device 140, the oven 142, and the packaging station 144. As such, the first pneumatic arm 150 and the second pneumatic arm 152 are configured for transporting the crust 204 between the food stations 104 by using the first end effector 224 and the second end effector 228 to lift the transport plate 174 with the crust 204 from the food stations 104 and maneuver the transport plate 174 about the kitchen 102. While the first pneumatic arm 150 is configured for engaging with an moving the transport plate 174 between the food stations 104 in the dough preparation area 160 and the ingredients assembly area 162, and the second pneumatic arm 152 is configured for engaging with and moving the transport plate 174 between the food stations 104 in the ingredients assembly area 162 and the cooking area 164.

With continued reference to FIG. 1, the first pneumatic arm 150, including the first end effector 224, is supported in the kitchen 102 by a first base 232. The second pneumatic arm 152, including the second end effector 228, is supported in the kitchen 102 by a second base 234. The first base 232 is positioned near the second base 234 in the kitchen 102 such that the food stations 104 can be arranged around the first pneumatic arm 150 and the second pneumatic arm 152 in the first L-shape 170 and the second L-shape 172.

On preparing a pizza as a food item in the food preparation system 100, the crust 204 is dispensed from the storage container 130 as a dough ball, pressed into flattened dough at the press 132, and sauced at the sauce distribution device 134, where the crust 204 is transported on the transport plate 174 by the first pneumatic arm 150, through the first end effector 224 and from the first base 232. The crust 204 is provided toppings at the toppings distribution device 140, baked in the oven 142, and then cut, packaged, and dispensed from the kitchen 102 at the packaging station 144, where the crust 204 is transported on the transport plate 174 by second the second pneumatic arm 152, through the second end effector 228 from the second base 234. The packaging station 144 is configured to cut the crust 204 into slices as a finished pizza with the cutting tool 184, package the crust 204 by folding a box around the crust 204 with the boxing arms 190, and dispense the crust 204 through the wall 180 for consumption by the user 120.

With this construction, the transport plate 174 is designed for being held by the first pneumatic arm 150 and the second pneumatic arm 152 using the first end effector 224 and the second end effector 228 for moving the transport plate 174 with the crust 204 between the food stations 104. The first base 232 is stationary with respect to the kitchen 102, and supports the first pneumatic arm 150 from a central position in the kitchen 102. The second base 234 is stationary with respect to the kitchen 102, and supports the second pneumatic arm 152 from the central position in the kitchen 102. The first end effector 224 is attached to the first distal end portion 226 of the first pneumatic arm 150, and is operable to grip the transport plate 174 with the crust 204 thereon, enabling the first pneumatic arm 150 to move the transport plate 174 and the crust 204 between the food stations 104. The second end effector 228 is attached to the distal end portion 230 of the second pneumatic arm 152 in the kitchen 102, and is operable to grip the transport plate 174 with the crust 204 thereon, enabling the second pneumatic arm 152 to move the transport plate 174 and the crust 204 between the food stations 104.

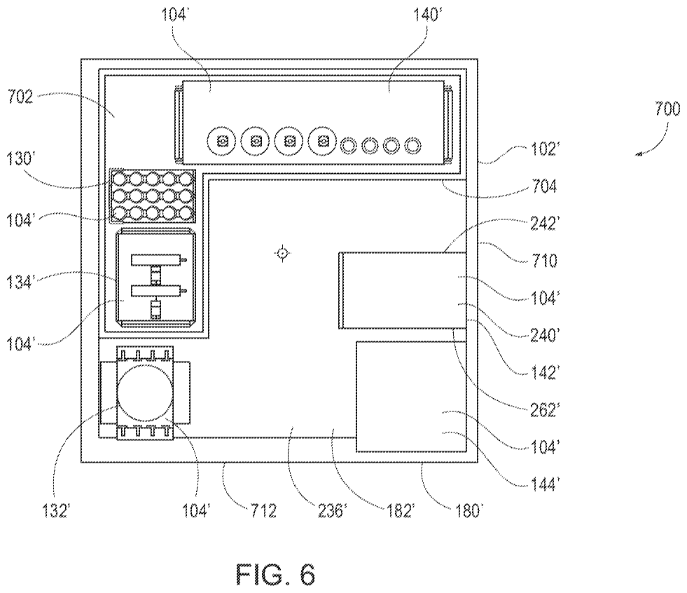

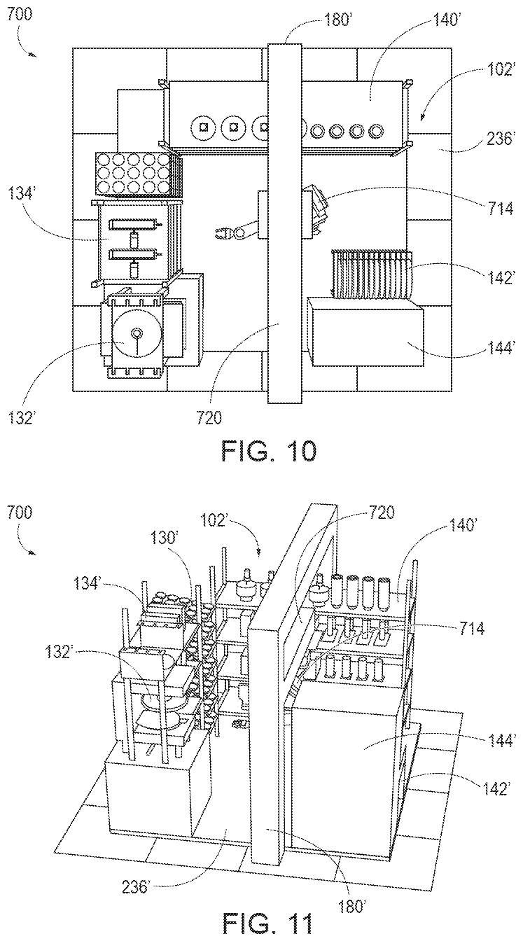

Notably, while each of the first pneumatic arm 150 and the second pneumatic arm 152 are depicted as a pneumatic arm, the first pneumatic arm 150 and the second pneumatic arm 152 are included in the kitchen 102 as the transport mechanism 112, and may respectively embody other alternative types of mechanical or otherwise robotic arms similarly configured for use in the kitchen 102 without departing from the scope of the present disclosure. Also, the kitchen 102 may include more or fewer than two robotic arms as the transporter or transport mechanism without departing from the scope of the present disclosure. Also, while each of the first pneumatic arm 150 and the second pneumatic arm 152 are depicted with the first base 232 and the second base 234 mounted on a floor 236 of the kitchen 102, the first base 232 and the second base 234 may respectively support the first pneumatic arm 150 and the second pneumatic arm 152 from the wall 180, a ceiling (not shown), or an overhang (see FIGS. 6-11) without departing from the scope of the present disclosure.

The food preparation system 100 includes a rack 240 configured for storing at least one utensil, such as the transport plate 174′, in a manner for being retrieved and maneuvered by the first pneumatic arm 150 in the kitchen 102′. In the depicted embodiment, the rack 240 is configured for supporting a plurality of transport plates having similar features and functioning in a similar manner as the transport plate 174 described herein. The first pneumatic arm 150 is configured to remove the transport plate 174 from the rack 240, receive the crust 204 on the transport plate 174 from the storage container 130, and place the transport plate 174 on the first indexing table 210, the second indexing table 212, the third indexing table 214, the fourth indexing table 220, and the fifth indexing table 222.

In an embodiment, the first pneumatic arm 150 can have 6 degrees of freedom with the first end effector 224, and reach a length of 1.6 meters or more when reaching around the production line 110 from the first base 232. In a further embodiment, the first end effector 224 can open to a maximum of 1″ or more for gripping the transport plate 174. In a further embodiment, the first pneumatic arm 150 can rotate up to 360 degrees on the first base 232. In a further embodiment, an accuracy of the first pneumatic arm 150 is at least 0.1 mm.

As shown in FIG. 1, the crust 204 is supported on the transport plate 174 between the food stations 104, and in various states of preparation about in the kitchen 102. The transport plate 174 is configured for supporting the crust 204 in the press 132 on the first indexing table 210, the sauce distribution device 134 on the second indexing table 212, the toppings distribution device 140 on the third indexing table 214, the oven 142 on the fourth indexing table 220, and the packaging station 144 on the fifth indexing table 222. The first pneumatic arm 150 and the second pneumatic arm 152 are configured for transporting the crust 204 on the transport plate 174 between the storage container 130, the press 132, the sauce distribution device 134, the toppings distribution device 140, the oven 142, and the packaging station 144.

The transport plate 174 can be made of different materials and is preferably heated or preheated by electrical heating resistors so that dough does not stick to the transport plate 174 and is preheated during subsequent working phases in order to maintain strength necessary to slide into, and not deform in the oven 142, and to shorten a corresponding minimum baking time. The transport plate 174 also serves as a dough support for the crust 204 during formation of flattened dough in the press 132, and as a support at an oven entrance 242 of the oven 142 during the insertion of the flattened dough into the oven 142. The transport plate 174 is subsequently transported to the packaging station 144 where the pizza is cut, packaged, and dispensed for consumption. In an embodiment not shown, the transport plate 174 is shaped as a baking sheet configured to support the crust 204 in the oven 142, and is pushed into the oven 142 together with the crust 204 by the second pneumatic arm 152.

Forming the crust 204 as flattened dough takes place under the press 132 which, by lowering a press plate 244 against the transport plate 174 positioned underneath, squeezes the dough ball forming the crust 204 flat to a predetermined shape and thickness. As depicted, the press plate 244 is a horizontal, lowerable, heated plate provided with a press plate edge 250 that is spaced horizontally by springs (not shown) at a distance from an outer edge of the transport plate 174.

In an embodiment, the press plate edge 250 is substantially ring shaped to give the crust 204 a substantially round shape. In another embodiment, the press plate edge 250 is substantially rectangular shaped to give the crust 204 a substantially rectangular shape. During the pressing process, dough in the crust 204 swells out laterally between the transport plate 174 and the press plate 244 and forms a bulge in a space between the press plate edge 250 and the transport plate 174. During a food preparation process including pressing the crust 204 with the press plate 244, the first indexing table 210 locates the crust 204 and the transport plate 174 under the press plate 244, and the press plate 244 is lowered to the transport plate 174 until the crust 204 is pressed flat. During this phase the springs are compressed between a holder (not shown) of the press plate edge 250 and the press plate edge 250. When the press plate 244 is raised, the springs relax. The bulge in the crust 204 forms a barrier to a subsequently distributed tomato paste, sauce, and/or puree that is unable to run over the edge of the crust 204. With the above described aspects, the kitchen 102 is configured to shape flattened crust 204 in a time-saving manner, even when individual customer orders call for different amounts of dough, to always form a regular, round or rectangular, flattened dough crust 204 with a thicker upwardly projecting edge region formed from the bulge. The transport plate 174 and press plate 244 being heated prevents the crust 204 from sticking to the respective plate surfaces, while preheating the crust 204.

While the depicted press plate 244 has a circular shape for forming the crust 204 with a circular shape, the press plate 244 may additionally or alternatively have a rectangular, square, oval, polygonal, curved, regular, or irregular shape for forming the crust 204 without departing from the scope of the present disclosure. While, as depicted, the crust 204 is formed with a circular shape and the cutting tool 184 is configured for cutting slices as sectors in the circular shape, the cutting tool 184 may additionally or alternatively cut slices having a rectangular, square, oval, polygonal, curved, regular, or irregular shape without departing from the scope of the present disclosure.

With continued reference to FIG. 1, after the crust 204 is shaped into flattened dough, the transport plate 174 with the crust 204 thereon is moved under the sauce distribution device 134. The sauce distribution device 134 is configured for dispensing tomato paste, sauces, purees, and similar liquid and/or spreadable food items on the crust 204. The sauce distribution device 134 is configured to dispense layers of food items on the crust 204 via a peristaltic pump 252 and a nozzle ring 254 so that several product quantities can be scattered on patties of crust 204 positioned underneath. In an embodiment, the distribution of food items on the crust 204 via the sauce distribution device 134 is aided by several air jets formed from air suitable for food, where the air jets are directed by air nozzles (not shown) attached in an area of the nozzle ring 254 and are directed at the product quantities lying on the crust 204. By using the peristaltic pump 252 in which a supply line, a discharge line, a pump part, and the nozzle ring 254 form a single piece of hose, it is possible to exchange an entire hose through which the food item flows for improving an ease in cleaning the sauce distribution device 134.

After the sauce distribution device 134, the transport plate 174 goes through the toppings distribution device 140 that is a section of the kitchen 102 configured for dispensing toppings on the crust 204. The toppings distribution device 140 is a dosing device for garnish ingredients having several dosing stations 260 which can all be of the same or different types. In an embodiment not shown, the toppings distribution device 140 is packaged in a bubble belt with a feed of gelling ingredients, the ingredients being sealed in individual portions in bubbles between two plastic films, possibly in a controlled atmosphere. In another embodiment not shown, the garnishing ingredients are packaged in small trays where several shells form a stack and a bottom of an upper bowl forms a lid of a lower bowl, where the stack of trays can be packed in a controlled atmosphere. The packaging systems described herein enable hygienic, food-friendly packaging, precise portioning, simple, compact storage within a cooled container in the form of rolls or stacks of trays and targeted, waste-free placement on the flat surface.

Each metering device in the toppings distribution device 140, such as a plastic film or bowl for storing measured amounts of food items, can be combined with a scattering device attached underneath. In an embodiment, the toppings distribution device 140 is a dosing device for food items such as finely chopped cheese, pieces of ham, and vegetables. The food items fall from the nozzle ring 254 to fall on the scattering device, and is scattered by the scattering device through a sieve and/or a grating on the underlying crust 204 by vibration. Screens and/or grids are easily interchangeable and made of dishwasher-safe material or of materials which provide for one-way use, which makes it possible to maintain hygiene in a simple manner, by changing the screen. Unrolled foil tapes can run in a separate container or can run back into a container of the blister strip.

The toppings distribution device 140 features ingredients packed in tray stacks which are introduced into chilled magazines configured for being removed from below by moving a slide, brought to a tipping station for emptying, and placed as empty trays. In an embodiment, the scattering device already described is located below the tilting station. In an embodiment, food items are placed on the crust 204 by the toppings distribution device 140 in a clustered form without a scattering device.

Depending on orders made by individual users, only certain garnish ingredients may be applied to the same crust 204, or in other cases double or triple the amount of the same garnish ingredients may be applied. In an embodiment of the kitchen 102 where an individual order calls for double, triple, or otherwise more or less than a nominal portion of an ingredient, the crust 204 is provided under the toppings distribution device 140 for a period of time corresponding with the appropriate amount of garnish ingredients being scattered thereon, where the toppings distribution device 140 dispenses the ingredients at a controlled rate over time. The toppings distribution device 140 is configured to provide several magazines for bowl stacks in the dosing stations 260 with different ingredients, which can be removed via the same slide and all can be scattered on the crust 204 at the toppings distribution device 140 as a same production station. The shells of trays are divided into cells and may also be provided with a grate or grid, and in this way a uniform distribution of ingredients on the crust 204 can be achieved in view of a corresponding diameter of the shell and an arrangement of the product in cells. In the case of trays with a grate or grid, however, the ingredients can be scattered by vibrating an opened and possibly tilted tray.

The oven 142 is designed for baking an individual crust 204 for producing an individual pizza. The garnished crust 204, which is continuously preheated via the transport plate 174 during the individual working phases of the food stations 104 described, can be inserted in a traditional, mechanical manner or by means of an insertion device which is provided on the transport plate 174 itself.

As shown in FIG. 1, the oven 142 defines the oven entrance 242 as an insertion opening, and an oven exit 262 as a removal opening. The oven 142 includes two oven doors 264 respectively located at the oven entrance 242 and oven exit 262. The oven doors 264 are swing doors configured for moving between an open position and a closed position with respect to the oven 142.

The transport plate 174 is ventilated on an underside to form hot air chambers as hypocausts in the transport plate 174. The transport plate 174 and the oven 142, including the two oven doors 264, are made of porous, vapor-permeable ceramic configured to absorb baking vapors in an exchange of air (breathing), and thus produce a pizza that tastes as though the pizza were baked in a charcoal oven. The oven 142 has a corresponding warm tunnel 270 extended between the oven entrance 242 and at the oven exit 262, thereby preventing the air exchange in an actual baking zone with preheated air by waste heat during insertion or removal of the crust 204 with respect to the oven 142.

Parts of a method for producing a pizza with the kitchen 102 include material transportation by means of automation technologies; storage of ingredients and crust 204 as pizza dough; dispensing of sauce and topping ingredients as noted in a preprogrammed recipe; and baking the crust 204 with all ingredients in the oven 142. These parts of the method are automated in the kitchen 102, where, in an embodiment, the entire system is integrated with a robot and programmable logic controller (PLC).

With continued reference to FIG. 1, storage of ingredients is done in the storage container 130, which is a structure that optimizes refrigerated interior space available in a typical residential or commercial kitchen. As depicted, storage bins 272 configured for handling the crust 204 as a dough ball are stacked at various levels in the storage container 130, with the number of storage bins 272 depending on the physical dimensions and the capacity of a corresponding restaurant.

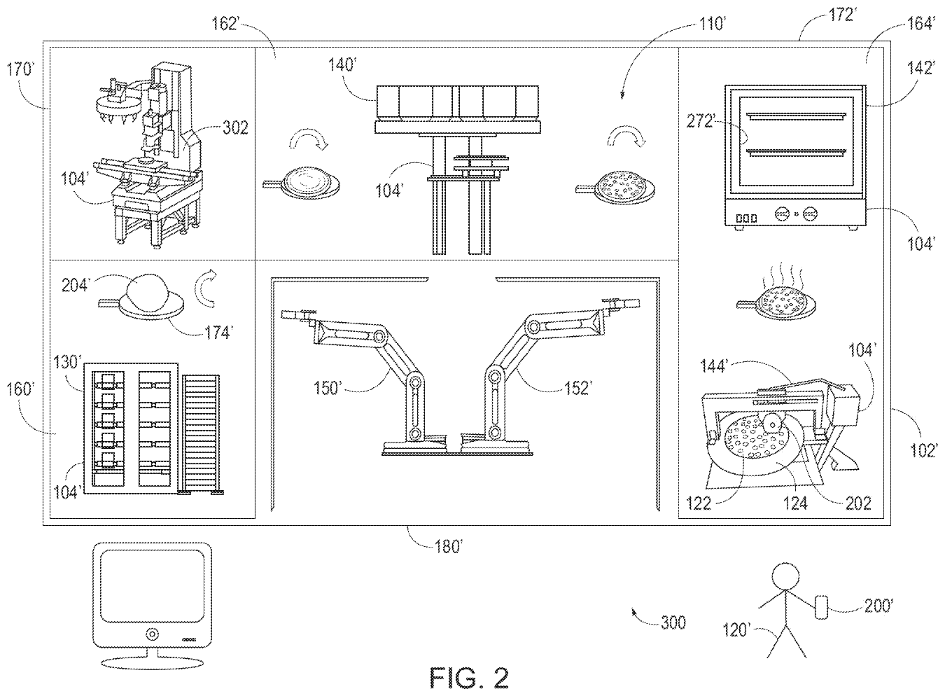

FIG. 2 depicts a food preparation system 300 as an alternate embodiment of the food preparation system 100 of FIG. 1, where the press 132 and the sauce distribution device 134 are provided in a single press and sauce distribution apparatus. In the embodiment of FIG. 2, like elements with the food preparation system 100 of FIG. 1 are denoted with the same reference numerals but followed by a primed suffix(′).

As shown in FIG. 2, the food preparation system 300 includes a press and sauce distribution apparatus 302 that is a single, standalone apparatus arranged between the storage container 130′ and the toppings distribution device 140′ along the production line 110′. The press and sauce distribution apparatus is configured to flatten dough and dispense sauce in a manner similar to the press and sauce distribution device of FIG. 1.

With reference to FIG. 2, the storage container 130′, the press and sauce distribution apparatus 302, and the toppings distribution device 140′ are arranged around the first pneumatic arm 150′ such that the production line 110′ is angled around the first pneumatic arm 150′ at the press and sauce distribution apparatus 302, forming the first L-shape 170′ in the production line 110′ around the first pneumatic arm 150′ at the press and sauce distribution apparatus 302. The toppings distribution device 140′, the oven 142′, and the packaging station 144′ are arranged around the second pneumatic arm 152′ such that the production line 110′ is angled around the second pneumatic arm 152′ at the oven 142′, forming the second L-shape 172′ in the production line 110′ around the second pneumatic arm 152′ at the oven 142′.

With this configuration of food stations 104′ in the kitchen 102′ arranged around the first pneumatic arm 150′ and the second pneumatic arm 152′, the food preparation system 300 is relatively compact, reducing an overall floorspace of the kitchen 102′ necessary for enclosing the food preparation system 300. Also, the dough preparation area 160 and the ingredients assembly area 162′ overlap at the press and sauce distribution apparatus 302, at a corner of the first L-shape 170′.

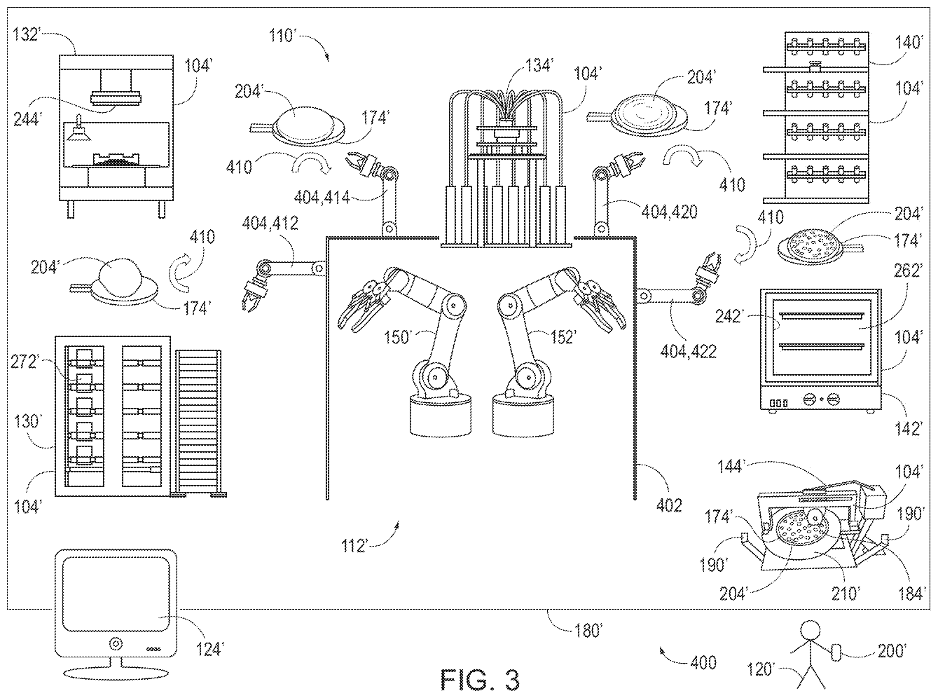

FIG. 3 depicts a food preparation system 400 as an alternate embodiment of the food preparation system 100 of FIG. 1, where the transport mechanism 112 is provided a plurality of supportive robot arms positioned between food stations 104 along the production line 110. In the embodiment of FIG. 3, like elements with the food preparation system 100 of FIG. 1 are denoted with the same reference numerals but followed by a primed suffix(′).

As shown in FIG. 3, the food preparation system 400 includes a support 402 disposed along the production line 110′. The transport mechanism 112′ includes a plurality of station arms 404 mounted on the support 402, between the food stations 104′ along the production line 110′. The plurality of station arms 404 are robot arms configured for transporting ingredients on the transport plate 174′ between the food stations 104′ along the production line 110′ as indicated by corresponding arrows 410. The plurality of station arms 404 have a construction similar to the first pneumatic arm 150′ and the second pneumatic arm 152′ for maneuvering the transport plate 174′ with the dough through the kitchen 102′ cooperatively with the first pneumatic arm 150′ and the second pneumatic arm 152′. With this construction, at least one of the first pneumatic arm 150′, the second pneumatic arm 152′, and the station arms 404 may hold the transport plate 174′ with food items thereon while another of the first pneumatic arm 150′, the second pneumatic arm 152′, and the station arms 404 manipulates the food items on the transport plate 174′, optionally with a utensil removably mounted on the support 402.

The plurality of station arms 404 includes a first station arm 412, a second station arm 414, a third station arm 420, and a fourth station arm 422. The first station arm 412 is arranged between the storage container 130′ and the press 132′ along the production line 110′ for transporting a crust 204′ from the storage container 130′ toward the press 132′ via the transport plate 174′. The second station arm 414 is arranged between the press 132′ and the sauce distribution device 134′ along the production line 110′ for transporting crust 204′ from the press 132′ toward the sauce distribution device 134′ via the transport plate 174′. The third station arm 420 is arranged between the sauce distribution device 134′ and the toppings distribution device 140′ along the production line 110′ for transporting crust 204′ from the sauce distribution device 134′ toward the toppings distribution device 140′ via the transport plate 174′. The fourth station arm 422 arranged between the toppings distribution device 140′ and the oven 142′ along the production line 110′ for transporting the crust 204′ from the toppings distribution device 140′ toward the oven 142′ via the transport plate 174′.

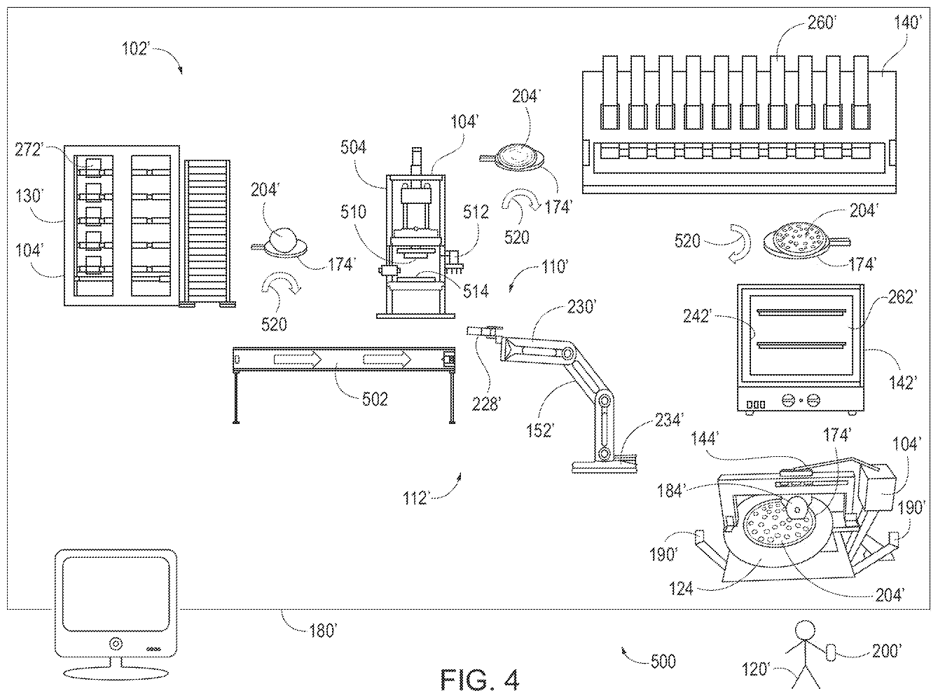

FIG. 4 depicts a food preparation system 500 as an alternate embodiment of the food preparation system 100 of FIG. 1, where the transport mechanism 112 includes a conveyor system configured to transport food items along the production line 110 with the second pneumatic arm 152, and where the press 132 and the sauce distribution device 134 are provided in a single press and sauce distribution apparatus. In the embodiment of FIG. 4, like elements with the food preparation system 100 of FIG. 1 are denoted with the same reference numerals but followed by a primed suffix(′).

As shown in FIG. 4, the food preparation system 500 includes a conveyor 502 operatively connected with the storage container 130′ and a press and sauce distribution apparatus 504. The press and sauce distribution apparatus 504 includes a press plate 510 and a sauce distribution arm 512 arranged above an indexing table 514. The indexing table 514 is configured to move the transport plate 174′ with the crust 204′ thereon, between a position beneath the press plate 510 and a position beneath the sauce distribution arm 512. As such, the press and sauce distribution apparatus 504 is configured to press and distribute sauce on the crust 204′ with the crust 204′ provided on the indexing table 514.

The conveyor 502 is configured for transporting the crust 204′ from the storage container 130′ to the press and sauce distribution apparatus 504. The storage container 130′ is configured to selectively dispense portions of dough forming the crust 204′ on the transport plate 174′, where the transport plate 174′ is carried by the conveyor 502 from the storage container 130′ to the press and sauce distribution apparatus 504. As such, the storage container 130′ is configured to selectively dispense the crust 204′ onto the conveyor 502 for transport to the press and sauce distribution apparatus 504. The press and sauce distribution apparatus 504 is operably connected with the conveyor 502 for receiving the crust 204′, on the transport plate 174′, from the conveyor 502 such that the crust 204′ is supported on the transport plate 174′ in the press and sauce distribution apparatus 504.

The food preparation system 500 includes both the second pneumatic arm 152′ and the conveyor 502 as the transport mechanism 112′ configured to transport the crust 204′ between the food stations 104′ in the general direction of food production as indicated by arrows 520. In this manner, the transport mechanism 112′ may include a combination of devices including robotic arms and conveyor systems configured to cooperatively maneuver and transport the crust 204′ between the food stations along the production line 110′.

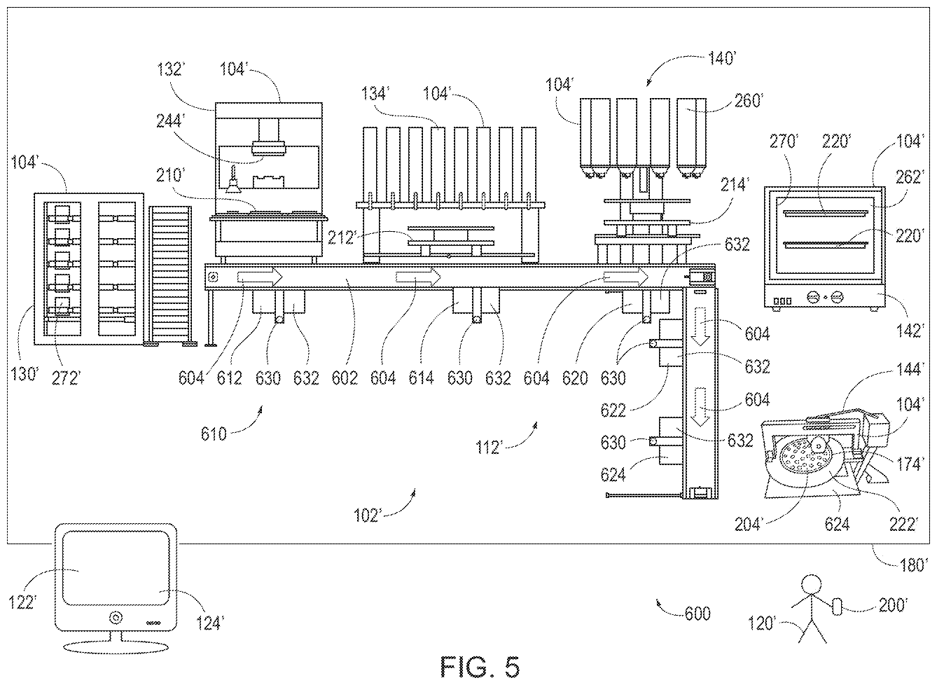

FIG. 5 depicts a food preparation system 600 as an alternate embodiment of the food preparation system 100 of FIG. 1, where the transport mechanism 112 is a conveyor system. In the embodiment of FIG. 5, like elements with the food preparation system 100 of FIG. 1 are denoted with the same reference numerals but followed by a primed suffix(′).

As shown in FIG. 5, the kitchen 102′ includes a conveyor 602 as the transport mechanism 112′ configured to transport the crust 204′ about the kitchen 102′ in the general direction of food production indicated by arrows 604. The conveyor 502 is used to move the transport plate 174′ from the storage container 130′ to the toppings distribution device 140′, where the crust 204′ collects the ingredients by stopping at the toppings distribution device 140′ and waiting for the ingredients to be dispensed thereon from the dosing stations 260′. Once the crust 204′ has been assembled with food items at the toppings distribution device 140′, the conveyor 602 transports the crust 204′ from the ingredients assembly area 160′, through the oven 142′, and to the packaging station 144′. The oven 142′ can include a wave oven, an electrically heated oven chamber, or be an open ended pizza oven capable of cooking the crust 204′ in less than five minutes. In an embodiment, the wave oven has twelve (12) high wattage halogen lamps for use with a 40 amp, 240 volt circuit.

The transport plate 174′ is designed for being carried by the conveyor 602. The transport plate 174′ is also configured to support the crust 204′ on the conveyor 602, and support the crust 204′ in the press 132′, the sauce distribution device 134′, the toppings distribution device 140′, the oven 142′, and the packaging station 144′, including the cutting tool 184′. The sauce distribution device 136′, the toppings distribution device 140′, the oven 142′, and the cutting tool 184′ are operatively connected with the conveyor 602 through a plurality of stoppers 610 for receiving food items, including the crust 204′, from the conveyor 602. The plurality of stoppers 610 includes a first stopper 612, a second stopper 614, a third stopper 620, a fourth stopper 622, and a fifth stopper 624.

The first stopper 612 is fixed with the conveyor 602 and configured for driving the crust 204′ from the conveyor 602 to the press 132′. The first stopper 612 is also configured for receiving the crust 204′ from the press 132′ and placing the crust 204′ onto the conveyor 602. The second stopper 614 is fixed with the conveyor 602 and configured for driving the crust 204′ from the conveyor 602 to the sauce distribution device 134′. The second stopper 614 is also configured for receiving the crust 204′ from the sauce distribution device 134′ and placing the crust 204′ onto the conveyor 602. The third stopper 620 is fixed with the conveyor 602 and configured for driving the crust 204′ from the conveyor 602 to the toppings distribution device 140′. The third stopper 620 is also configured for receiving the crust 204′ from the toppings distribution device 140′ and placing the crust 204′ onto the conveyor 602. The fourth stopper 622 is fixed with the conveyor 602 and configured for driving the crust 204′ from the conveyor 602 to the oven 142′. The fourth stopper 622 is also configured for receiving the crust 204′ from the oven 142′ and placing the crust 204′ onto the conveyor 602. The fifth stopper 624 is fixed with the conveyor 602 and configured for driving the crust 204′ from the conveyor 602 to the packaging station 144′, including the cutting tool 184′. In an embodiment, the fifth stopper 624 is also configured for receiving the crust 204′ from the packaging station 144′ and placing the crust 204′ onto the conveyor 602, where the conveyor 602 is configured to deliver the crust 204′ through the wall 180 for access by the user 120′.

Each stopper in the plurality of stoppers 610 includes a stopper arm 630 and a stopper plate 632, where the stopper arm 630 is fixed with the conveyor and configured for driving the stopper plate 632 relative to a corresponding station. The stopper plate 632 is configured for engaging and maneuvering food items between the corresponding food station 104′ and the conveyor 602 when actuated by the stopper arm 630. While each depicted stopper in the plurality of stoppers 610 includes a stopper plate 632 for engaging and maneuvering food items between the corresponding food station 104′ and the conveyor 602, the stopper plate 632 may additionally or alternatively include features complementary with specific food items such as a pizza peel, tongs, spatula, spoon, or fork for preparing pizza at various food stations 104′, without departing from the scope of the present disclosure. Each stopper plate 632 in the plurality of stoppers 610 may also additionally or alternatively include prongs, sidewalls, moveable fingers, and other features for maneuvering a variety of food items and locating the stopper plate 632 relative to the conveyor 602 and the corresponding food station 104′ without departing from the scope of the present disclosure.

As shown in FIG. 5, the crust 204′ can be moved, slid, or rotated by the first indexing table 210′, the second indexing table 212′, the third indexing table 214′, the fourth indexing table 220′, the fifth indexing table 222′ relative to the conveyor 602 and the corresponding food station 104. As such each of the press 132′, the sauce distribution device 134′, the oven 142′, and the packaging station 144′ includes an indexing table configured for receiving and positioning the crust 204′ off the conveyor 602.

In the ingredients assembly area 162, a user can view one or more toppings, as selected, being automatically dispensed on the crust 204′ from the toppings distribution device 140′. After the toppings distribution device 140′, the crust 204′ is conveyed to the oven 142′ where the crust 204′ is cooked. The cooked crust 204′ is transported to the packaging station 144′ and cut, packaged, and dispensed in a cardboard box, carton, disposable plate, or similar container for transport or take-out by the user 120 to a desired eating area.

In the ingredients assembly area 162, toppings and sauces are automatically dispensed and injected on the crust 204′. In an embodiment, the toppings and sauces are stored in a transparent box with a 4 to 6 degree temperature level, and are positioned above the crust 204′ in the ingredients assembly area 162 to enhance dispensing of toppings and promote sanitation, ease of handling and replacement in the food preparation system 600. The dosing stations 260 of the toppings distribution device 140′ have various technologies configured to dispense various ingredients in accordance with properties of the respective ingredients. In an embodiment, each dosing station 260′ respectively contains a different topping. The storage bins 272′ can be sequentially dispensed and emptied by using various types of technologies, such as an auger mechanism, a tablet dispensing mechanism, and/or a conveyor mechanism which are regulated and controlled by solenoids or solenoid valves connected to the PLC. In an embodiment, an air compressor with a dryer and trap can provide the pneumatic pressure to raise and lower cylinders at a desired speed. Ingredients including toppings are dispensed, injected and placed on the crust 204′ at the toppings distribution device 140′ in a selected pattern, array or matrix, as programmed or preset by the PLC.

In the ingredients assembly area 160′, selected pizza toppings are automatically dispensed and pneumatically injected on the crust 204′ by pneumatically operated overhead cartridge tubes in the dosing stations 260. The toppings and the crust 204′ can be stored and assembled at refrigerated temperatures in the kitchen 102′.

An assembled pizza, including the crust 204′ with the selected toppings from the toppings distribution device 140′, is conveyed to the oven 142′, where the pizza is electrically cooked for a predetermined amount of time. In an embodiment, the pizza is fully cooked for consumption in less than five minutes.

After the pizza is cooked, the pizza is conveyed, charged, and dispensed into a pizza box 634 at the packaging station 144′. The pizza box 634 may have a name of the user or other identification, and identification of a type of pizza printed thereon. The pizza can then be automatically cut into slices with the cutting tool 184′, which is an overhead cutting tool included in the packaging station 144′ and driven across the crust 204′ for cutting slices in the pizza. The fifth indexing table 222′ is configured to reposition the crust 204′ with respect to the cutting tool 184′ for making cuts of different angles across the pizza, and the pizza box 634 is mechanically closed by the boxing arms 190′. The closed pizza box 634 is then conveyed and dispensed into a retrieving area accessible by the user 120′.

Each stopper 610 and food station 104′ along the production line 110′ is capable of independently maneuvering and supporting food items while the conveyor 602 transports additional food items down the production line 110′. In this manner, the food preparation system 600 is configured for adapting an order in which food items on the production line 110′ are prepared and when food items are transported by the conveyor 602, increasing an overall efficiency of the production line 110 in fulfilling multiple food items at once.

FIGS. 6-11 depict a food preparation system 700 as an alternate embodiment of the food preparation system 100 of FIG. 1. In the embodiment of FIGS. 6-11, like elements with the food preparation system 100 of FIG. 1 are denoted with the same reference numerals but followed by a primed suffix(′).

As shown in FIG. 6, the food preparation system 700 includes the storage container 130′, the press 132′, the sauce distribution device 134′, the toppings distribution device 140′, the oven 142′, and the packaging station 144′ as the food stations 104′ arranged in the kitchen 102′. The oven 142′ and the packaging station 144′ are arranged adjacent to each other in a corner of the kitchen 102′ opposite the storage container 130′, the press 132′, the sauce distribution device 134′, and the toppings distribution device 140′. As such, the oven 142′ and the packaging station 144′ are spaced from the remaining food stations 104′ across the closed space 182′ of the kitchen 102′. The storage container 130′, the press 132′, the sauce distribution device 134′, and the toppings distribution device 140′ form an L-shape 702 along the wall 180′ at a side of the kitchen 102′ opposite the oven 142′ and the packaging station 144′.

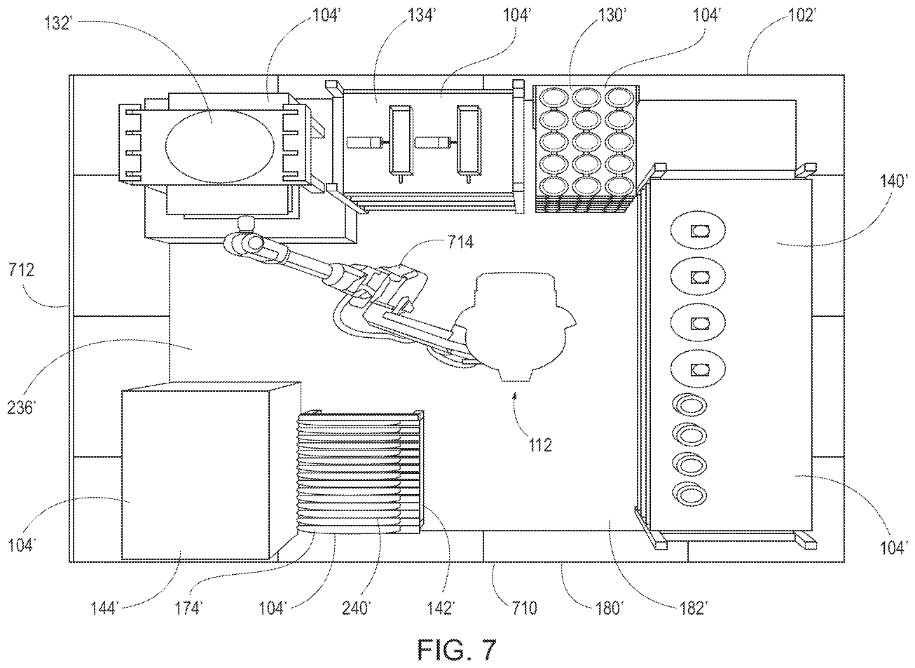

The food stations 104′ define a gap 704 between the L-shape 702, the oven 142′ and the packaging station 144′. The gap 704 is wide enough between the L-shape 702, the oven 142′, and the packaging station 144′ to form a walkable path along the floor 236′. The walkable path along the floor 236′ extends from a first portion 710 of the wall 180′ to a second portion 712 of the wall 180′, around the oven 142′ and the packaging station 144′, and along the toppings distribution device 140′, the storage container 130′, the sauce distribution device 134′, and the press 132′. As such, a person (not shown) with access to the closed space 182′ may walk through the kitchen 102′, around the oven 142′, and service the food stations 104′ and the transport mechanism 112′ (see FIG. 7).

With this construction, a travel distance of the crust 204′ from the oven 142′ to the packaging station 144′ is minimized, and a travel distance of heat from the oven 142′ to the other food stations 104′ is maximized in the kitchen. As such, minimal heat is lost from the crust before reaching the packaging station 144′, and waste heat from the oven 142′ is relatively secluded from the other food stations 104′.

The rack 240′ is configured for preheating the transport plate 174′ before the transport plate 174′ is used to support food items, including the crust 204′ during food preparation. As depicted, the rack 240′ is located above the oven 142′, however the rack 240′ and the oven 142′ may switch vertical positions in the kitchen 102′ such that the oven is located above the rack 240′, or otherwise be arranged adjacent with each other in the kitchen 102′ without departing from the scope of the present disclosure. As such, the rack 240′ defines the gap 704 with the L-shape 702 across the closed space 182′.

With this configuration, the food preparation system 700 is relatively compact, reducing an overall size of the kitchen 102′ necessary for enclosing the rack 240′ in the closed space 182′. Also, the food preparation system 700 is configured to recycle heat from the oven 142′ to the transport plate 174′ for preheating the transport plate, and prepare cooked food items faster, increasing an overall time and energy efficiency of the food preparation system 700. Also, the rack 240′ located with the oven 142′ and the packaging station 144′ in the kitchen 102′ maximizes a travel distance of heat from the rack 240′ to the remaining food stations 104′, secluding waste heat from the oven 142′ and the rack 240′ from the remaining food stations 104′.

As shown in FIG. 7, a pneumatic arm 714 is arranged in a central area of the kitchen 102′ with the food stations 104′ arranged along the wall 180′. With this configuration, the food stations 104′ are arranged around the pneumatic arm 714, within a reaching distance of the pneumatic arm 714. The pneumatic arm 714 includes similar features and functions in a similar manner as the first pneumatic arm 150′ and the second pneumatic arm 152′ with respect to transporting food items between the food stations 104′.

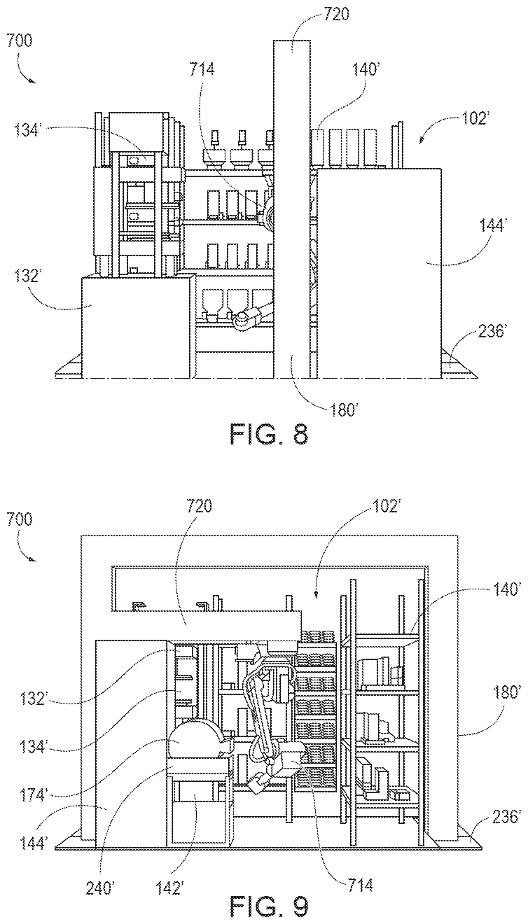

As shown in FIGS. 8-11, the pneumatic arm 714 is mounted to an overhang 720 extended from the wall 180′ toward the central portion of the kitchen 102′, above the floor 236′. With this construction, the pneumatic arm 714 is fixed with kitchen 102′, suspended above the floor 236′. While, as depicted, the overhang 720 is stationary with respect to the kitchen 102′, the overhang 720 may be mobile relative to the kitchen 102′, extending an effective reach of the pneumatic arm 714 about the kitchen 102′, without departing from the scope of the present disclosure.

With the kitchen 102, a method and corresponding device is provided for mechanical and automated production of ready-to-eat pizzas due based on individual customer order selection from a list. The food preparation system is configured to prepare the crust 204 from non-pre-cooked or frozen ingredients for the dough, where pizzas produced by the food preparation system 100 in the kitchen 102 are individually seasoned, garnished, colored and baked and are ready to eat within a short time in accordance with individual customer orders. Furthermore, with kitchen 102, the pizza making process and system operates hygienically and without human intervention, and maintenance of the system, including maintenance directed to hygiene and keeping the system clean, periodic automated washing and sterilizing cycles are provided and those parts which come into contact with the food and are not already exposed to the germicidal effect of the temperature can be replaced periodically. Furthermore, perishable food components of pizza produced in the kitchen 102 and empty packaging material is provided for food-compatible storage. Advantages realized by this construction include, but are not limited to improved performance of a pizza making process and system with regard to quality, reliability, safety, production costs, attraction and entertainment, labor costs, employee-benefit costs, insurance and overhead expenses, production volume, efficiency, and user friendliness.

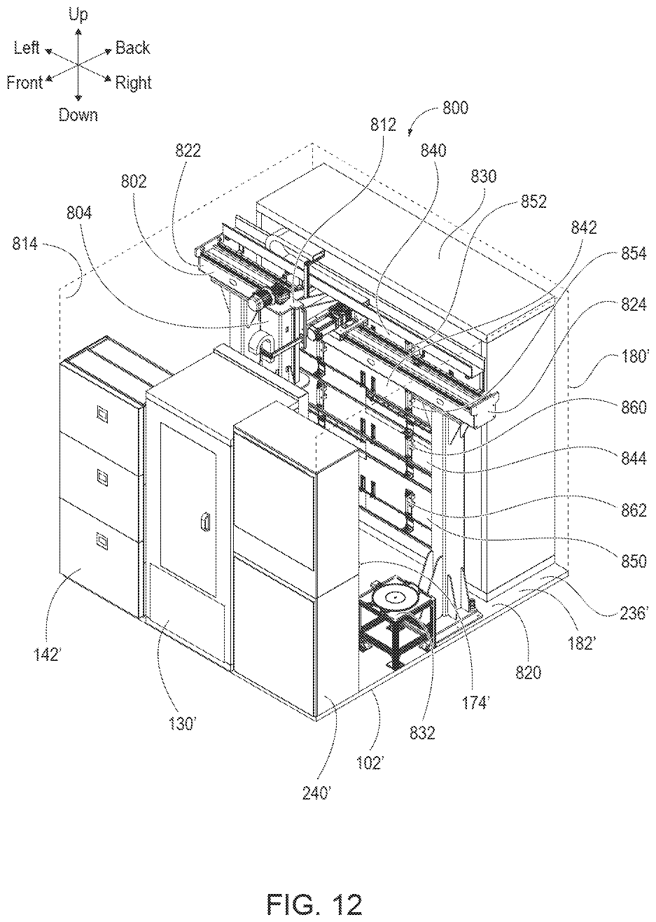

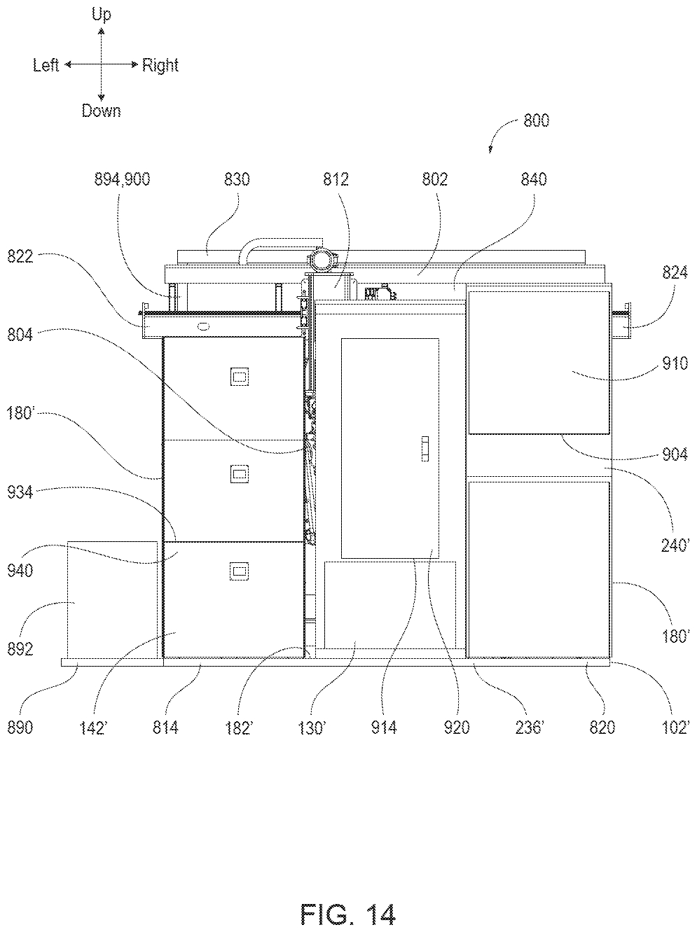

FIGS. 12-15 depict a food preparation system 800 as an alternate embodiment of the food preparation system 100 of FIG. 1. In the embodiment of FIGS. 12-15, like elements with the food preparation system 100 of FIG. 1 are denoted with the same reference numerals but followed by a primed suffix(′).

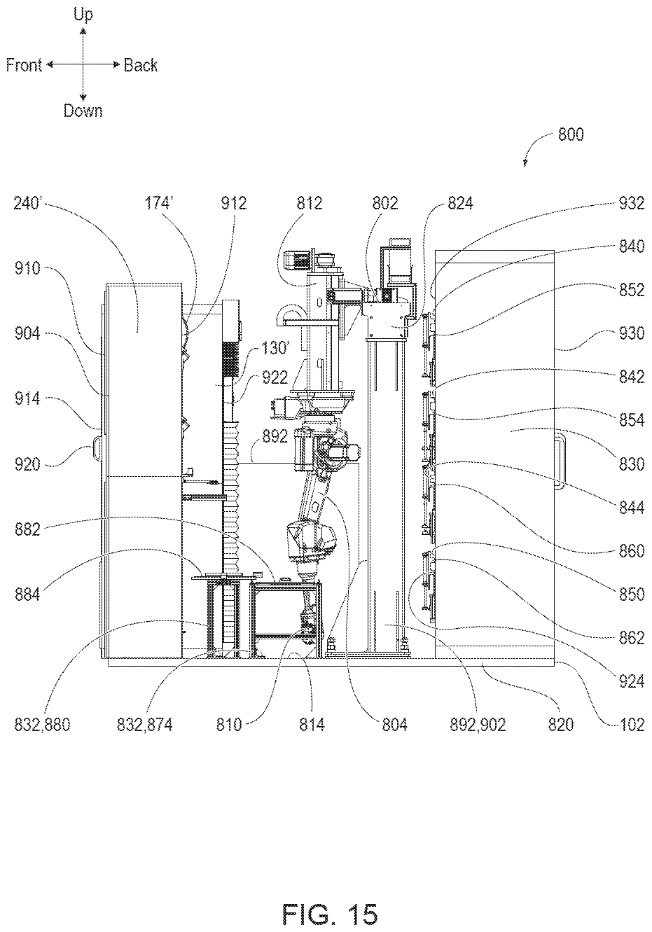

As shown in FIG. 12, the food preparation system 800 includes a gantry 802 fixed with the kitchen 102′, and a pneumatic arm 804 having an end effector 810 (FIG. 15) supported on a base 812 in the kitchen 102′. The pneumatic arm 804 includes similar features and functions in a similar manner as the first pneumatic arm 150′ and the second pneumatic arm 152′ with respect to transporting food items in the kitchen 102′.

The gantry 802 is a gantry configured to support the pneumatic arm 804 and facilitate movement of the pneumatic arm 804 along the gantry 802 relative to the kitchen 102′. The base 812 is movably mounted on the gantry 802, defining a reaching distance of the pneumatic arm 804 from the end effector 810 to the base 812, along a travel path of the base 812 on the gantry 802.

The kitchen 102′ includes the wall 180′ (drawn in hidden lines) and the floor 236′ defining a first kitchen end portion 814, and defining a second kitchen end portion 820 extended from the first kitchen end portion 814 in a width direction of the kitchen 102′ that is a left-right direction of the kitchen 102′. The gantry 802 includes a first gantry end portion 822, and a second gantry end portion 824 extended from the first gantry end portion 822, toward the second kitchen end portion 820 in the width direction of the kitchen 102′. The travel path of the base 812 along the gantry 802 extends between the first gantry end portion 822 and the second gantry end portion 824. With this construction, the first gantry end portion 822 is disposed in the first kitchen end portion 814 and the second gantry end portion 824 is disposed in the second kitchen end portion 820 such that the travel path of the base 812 along the gantry 802 extends through the kitchen 102′ between the first kitchen end portion 814 and the second kitchen end portion 820.

The food preparation system 800 includes the storage container 130′, the oven 142′, at least one ingredient distribution device 830, at least one press 832, and the rack 240′ arranged in the kitchen 102′, within the reaching distance of the pneumatic arm 804.

The storage container 130′ is a refrigerator configured for storing and dispensing dough, as a food item, on a transport plate 174′ retrieved from the rack 240′ by the pneumatic arm 804. The at least one press 832 is configured to press the dough on the transport plate 174′ to form a crust as a flattened dough.

The at least one ingredient distribution device 830 is configured for dispensing at least one ingredient directly on the transport plate 174′, or on a food item supported on the transport plate 174′. As depicted, the at least one ingredient distribution device 830 is a cabinet system configured to store ingredients and dispense the ingredients on a food item, such as a crust formed in the at least one press 832, and includes a first cabinet 840, a second cabinet 842, a third cabinet 844, and a fourth cabinet 850.

The first cabinet 840 is configured for storing sauce, and dispensing the sauce on a food item, such as a crust formed in the at least one press 832. The sauce is stored in an interior of the first cabinet 840 connected to a first cabinet outlet 852. The first cabinet outlet 852 is a valve actuated by the control system 114′ in conjunction with the pneumatic arm 804 for dispensing the sauce on the food item, with the food item supported on the transport plate 174′.

The second cabinet 842 is configured for storing cheese, and dispensing the cheese on a food item, such as a crust formed in the at least one press 832. The cheese is stored in an interior of the second cabinet 842 connected to a second cabinet outlet 854. The second cabinet outlet 854 is a valve actuated by the control system 114′ in conjunction with the pneumatic arm 804 for dispensing the cheese on the food item, with the food item supported on the transport plate 174′.

The third cabinet 844 is configured for storing meat, and dispensing the meat on a food item, such as a crust formed in the at least one press 832. The meat is stored in an interior of the third cabinet 844 connected to a third cabinet outlet 860. The third cabinet outlet 860 is a valve actuated by the control system 114′ in conjunction with the pneumatic arm 804 for dispensing the meat on the food item, with the food item supported on the transport plate 174′.

The fourth cabinet 850 is configured for storing vegetables, and dispensing the vegetables on a food item, such as a crust formed in the at least one press 832. The vegetables are stored in an interior of the fourth cabinet 850 connected to a fourth cabinet outlet 862. The fourth cabinet outlet 862 is a valve actuated by the control system 114′ in conjunction with the pneumatic arm 804 for dispensing the vegetables on the food item, with the food item supported on the transport plate 174′. The first cabinet 840, the second cabinet 842, the third cabinet 844, and the fourth cabinet 850 are arranged in descending order, downward in a height direction of the kitchen 102′ that is an up-down direction of the kitchen 102′ orthogonal to the width direction of the kitchen 102′, and orthogonal to a depth direction of the kitchen 102′ that is a front-back direction of the kitchen 102′.

Notably, with ingredients stored in the at least one ingredient distribution device 830 in a sequence corresponding to a recipe, an overall motion of the transport plate 174′ through the kitchen 102′ performed for acquiring ingredients thereon can be simplified and streamlined into a single direction. As such, with the described construction, recipes, including pizza recipes, calling for at least one of sauce, cheese, meat, and vegetables added onto a food item or the transport plate 174′ in that order can be performed through a streamlined, descending motion of the transport plate 174′ in the height direction of the kitchen 102′ as maneuvered by the pneumatic arm 804. The oven 142′ is configured for baking a food item, such as the crust and any ingredients dispensed thereon from the at least one ingredient distribution device 830, supported on the transport plate 174′.

In an embodiment, ingredients stored in the at least one ingredient distribution device 830 are stored as contents in individual containers disposed in the at least one ingredient distribution device 830, where the at least one ingredient distribution device 830 is configured to empty the contents in the individual containers and dispense the contents through one of the first cabinet outlet 852, the second cabinet outlet 854, the third cabinet outlet 860, and the fourth cabinet outlet 862.

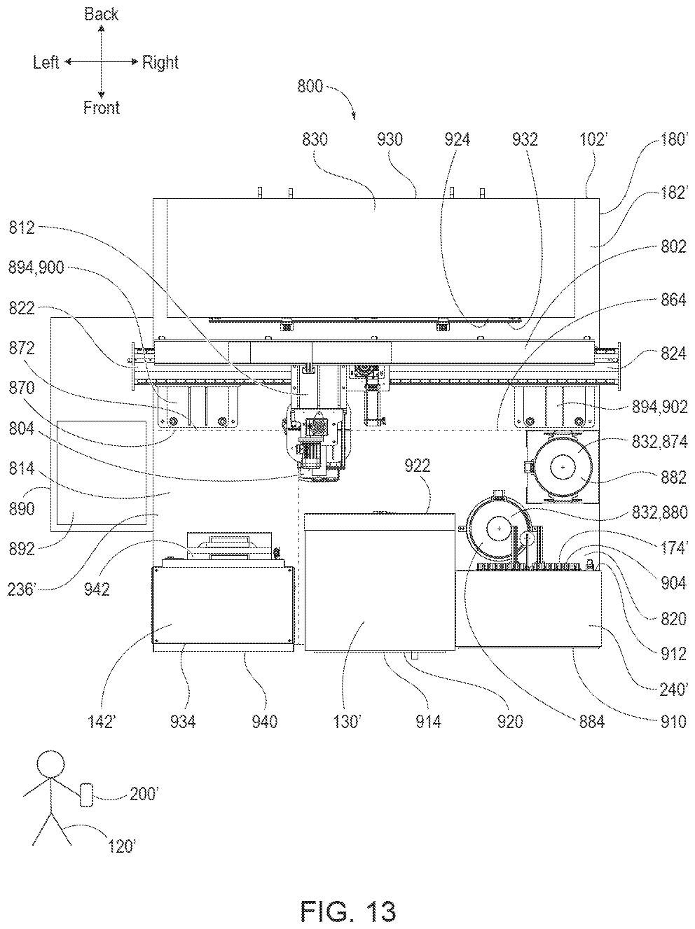

As shown in FIG. 13, the storage container 130′, the oven 142′, and the rack 240′ are arranged in that order in the width direction of the kitchen 102′, with the storage container 130′ interposed between and separating the oven 142′ and the rack 240′. The oven 142′ is located closer to the first gantry end portion 822 as compared to the second gantry end portion 824, and the rack 240′ being located closer to the second gantry end portion 824 as compared to the first gantry end portion 822.

The at least one ingredient distribution device 830 is located at a side of the gantry 802 opposite at least one of the storage container 130′ and the oven 142′ in the front-back direction of the kitchen 102′. As depicted, the at least one ingredient distribution device 830 is located at a side of the gantry 802 opposite each of the storage container 130′, the oven 142′, and the rack 240′ in the front-back direction of the kitchen 102′.

The at least one press 832 is located within the reaching distance of the robot arm. The at least one press 832 is disposed in the second kitchen end portion 820, where the at least one press 832 is located closer to the second gantry end portion 824 as compared to the first gantry end portion 822.

The at least one press 832 is also located between at least one of the storage container 130′, the oven 142′, and the rack 240′, and the at least one ingredient distribution device 830 in the front-back direction of the kitchen 102′. As depicted, the press is located between each of the storage container 130′, the oven 142′, and the rack 240′, and the at least one ingredient distribution device 830 in the front-back direction of the kitchen 102′.

With this construction, the rack 240′, the storage container 130′, and the at least one press 832 are arranged in the second kitchen end portion 820, across the gantry 802 from the at least one ingredient distribution device 830. As such, in preparing a flattened dough, the food preparation system 800 is configured to actuate the pneumatic arm 804 to retrieve the transport plate 174′ from the rack 240′, maneuver the transport plate toward the storage container 130 from the rack 240′, dispense dough from the storage container 130′ onto the transport plate 174′, maneuver the transport plate 174′ with the dough in the at least one press 832, and support the dough in the at least one press 832 while the at least one press 832 forms the dough into a flattened crust, without moving the pneumatic arm 804 from a corner of the kitchen 102′ in the second kitchen end portion 820, across the gantry 802 from the at least one ingredient distribution device 830. With the food preparation system 800 configured to prepare a flattened dough in one corner of the kitchen 102′, movement of the pneumatic arm 804 about the kitchen 102 required for carrying out a recipe calling for flattened dough is reduced, minimizing an associated production time and amount of actuated motion by the pneumatic arm 804 in the kitchen 102′.

With continued reference to FIG. 13, the at least one ingredient distribution device 830 is extended between the first kitchen end portion 814 and the second kitchen end portion 820 in the width direction of the kitchen 102′, and located across the gantry 802 from the rack 240′, the storage container 130′, and the at least one press 832 in the front-back direction of the kitchen 102′. As such, in acquiring ingredients on the transport plate 174′, including acquiring ingredients on a food item such as a flattened dough supported by the transport plate 174′, the food preparation system 800 is configured to maneuver the transport plate 174′ with the pneumatic arm 804 directly from either of the rack 240′, the storage container 130′ and the at least one press 832, toward the at least one ingredient distribution device across the gantry 802 in the front-back direction of the kitchen 102, minimizing an associated production time and amount of actuated motion by the pneumatic arm 804 in the kitchen 102′.

The oven 142′ disposed in the first kitchen end portion 814, across the gantry 802 from the at least one ingredient distribution device 830 in the front-back direction of the kitchen 102′. As such, in baking a food item on the transport plate 174′, including a food item such as a flattened dough formed at the at least one press 832, and having ingredients dispensed thereon at the at least one ingredient distribution device 830, the food preparation system 800 is configured to maneuver the transport plate 174′ with the pneumatic arm 804 directly from the at least one ingredient distribution device 830 toward the oven 142′, across the gantry 802 in the front-back direction of the kitchen 102′, minimizing an associated production time and amount of actuated motion by the pneumatic arm 804 in the kitchen 102′.

In the manner described above, the rack 240′, the storage container 130′, the at least one press 832, the at least one ingredient distribution device 830, and the oven 142′ are arranged in a production line. Along the production line of the food preparation system 800, the rack 240′, the storage container 130′, and the at least one press 832 are located in a dough preparation area 864, the at least one ingredient distribution device 830 is located in an ingredients assembly area 870, and the oven 142′ is located in a cooking area 872. The dough preparation area 864, the ingredients assembly area 870, and the cooking area 872 are progressive stages in the production line for carrying out a recipe, including a pizza or a flatbread food item recipe, and respectively include similar features and function in a similar manner as the dough preparation area 160, the ingredients assembly area 162, and the cooking area 164 for carrying out a recipe with a minimized production time and amount of actuated motion by the pneumatic arm 804 in the kitchen 102′.

With continued reference to FIG. 13, the at least one press 832 includes a first press 874 and a second press 880 configured for preparing flattened dough. Unless otherwise stated, each of the first press 874 and the second press 880 include similar features and function in a similar manner as the press 132 for forming dough into a flattened crust.

The first press 874 is an automatic press configured for actuating a first press plate 882 toward a food item supported in the first press 874. The first press plate 882 is driven automatically, without manipulation of the first press 874 by the pneumatic arm 804.

The second press 880 is a manual press configured for actuating a second press plate 884 toward a food item supported in the second press 880. The second press plate 884 is driven manually, through manipulation of the second press 880 by the pneumatic arm 804.

The food preparation system 800 includes a serving station 890 having a counter 892 within the reaching distance of the pneumatic arm 804. The counter 892 forms a flat top surface configured for receiving and supporting food items prepared in the kitchen 102′. In this manner, the food preparation system 800 is configured to actuate the pneumatic arm 804 to deliver food items prepared in the kitchen 102′ to the serving station 890, on the counter 892.

The counter 892 is located between at least one of the storage container 130′, the oven 142′, and the rack 240′, and the at least one ingredient distribution device 830 in the front-back direction of the kitchen 102′. The counter 892 is located at the first kitchen end portion 814, and the oven 142′ is disposed in the first kitchen end portion 814, such that the counter 892 and the oven 142′ are each located closer to the first gantry end portion 822 as compared to the second gantry end portion 824. With this construction, the food preparation system 800 is configured to maneuver the transport plate 174′ with the pneumatic arm 804 directly from the oven 142′ toward the serving station 890, minimizing an associated production time and amount of actuated motion by the pneumatic arm 804 in the kitchen 102′.

With continued reference to FIG. 13, the food preparation system 800 includes the wall 180′ and the floor 236′ defining the closed space 182′ of the kitchen 102′ inaccessible to the user 120′. The gantry 802, the base 812, the storage container 130′, the at least one ingredient distribution device 830, the oven 142′, the rack 240′, and the at least one press 832 are arranged in the closed space 182′, inaccessible to the user 120′. The counter 892 is arranged outside the closed space 182′, accessible to the user 120′.

The pneumatic arm 804 is configured for delivering a food item from the closed space 182′, through the wall 180′, and on the counter 892 for access by the user 120′. The user 120′ may be an end consumer of the food item delivered to the serving station 890, or an employee tasked with further delivering the food item from the kitchen 102′.

The gantry 802 includes gantry legs 894 fixed with and supported on the floor 236′. The gantry legs 894 include a first gantry leg 900 disposed in the first kitchen end portion 814, extending to the floor 236′ from the first gantry end portion 822. The gantry legs 894 also include a second gantry leg 902 disposed in the second kitchen end portion 820, extending to the floor 236′ from the second gantry end portion 824. With this construction, the gantry 802 is supported from the floor 236′ across the kitchen 102′ from the first kitchen end portion 814 to the second kitchen end portion 820.

The first gantry end portion 822 is mounted to the wall 180′ at the first kitchen end portion 814, and the second gantry end portion 824 is mounted to the wall 180′ at the second kitchen end portion 820. With this construction, the gantry 802 is supported from the wall 180′ across the kitchen 102′ from the first kitchen end portion 814 to the second kitchen end portion 820.

With reference to FIGS. 13-15, each of the rack 240′, the storage container 130′, the at least one ingredient distribution device 830, and the oven 142′ are manually accessible from a first side thereof for restocking and maintenance of the food preparation system 800. Each of the rack 240′, the storage container 130′, the at least one ingredient distribution device 830, and the oven 142′ are also accessible by the pneumatic arm 804 from a second side thereof for preparing food items in the kitchen 102′.

As shown between FIGS. 13-15, the rack 240′ defines a rack interior 904 configured for storing the transport plate 174′. The rack 240′ is configured for receiving the transport plate 174′ in the rack interior 904 through a first rack side 910 formed from a manually accessible door defining the rack interior 904. The rack 240′ is also configured for dispensing the transport plate 174′ from the rack interior 904 through a second rack side 912 opposite the first rack side 910 and defining the rack interior 904. The rack 240′ is oriented in the kitchen 102′ such that the second rack side 912 faces the gantry 802, and is located closer to the gantry 802 as compared to the first rack side 910.

The storage container 130′ defines a storage container interior 914 configured for storing a food item. The storage container 130′ is configured for receiving the food item in the storage container interior 914 through a first storage container side 920 formed from a manually accessible door defining the storage container interior 914. The storage container 130′ is also configured for dispensing the food item from the storage container interior 914 through a second storage container side 922 opposite the first storage container side 920 and defining the storage container interior 914. The storage container 130′ is oriented in the kitchen 102′ such that second storage container side 922 faces the gantry 802 and is located closer to the gantry 802 as compared to the first storage container side 920.

The at least one ingredient distribution device 830 defines a cabinet interior 924 configured for storing ingredients in each of the first cabinet 840, the second cabinet 842, the third cabinet 844, and the fourth cabinet 850. The at least one ingredient distribution device 830 is configured for receiving the ingredients in the cabinet interior 924 through a first cabinet side 930 formed from a manually accessible door defining the cabinet interior 924. The at least one ingredient distribution device 830 is also configured for dispensing the ingredients from the cabinet interior 924 through a second cabinet side 932 opposite the first cabinet side 930 and defining the cabinet interior 924. The at least one ingredient distribution device 830 is oriented in the kitchen 102′ such that the second cabinet side 932 faces the gantry 802 and is located closer to the gantry 802 as compared to the first cabinet side 930.

The oven 142′ defines an oven interior 934 configured for baking a food item. The oven 142′ is configured for receiving the food item in the oven interior 934 through a first oven side 940 formed from a manually accessible door defining the oven interior 934. The oven 142′ is also configured for dispensing the food item from the oven interior 934 through a second oven side 942 opposite the first oven side 940 and defining the oven interior 934. The oven 142′ is oriented in the kitchen 102′ such that the second oven side 942 faces the gantry 802, and is located closer to the gantry 802 as compared to the first oven side 940.

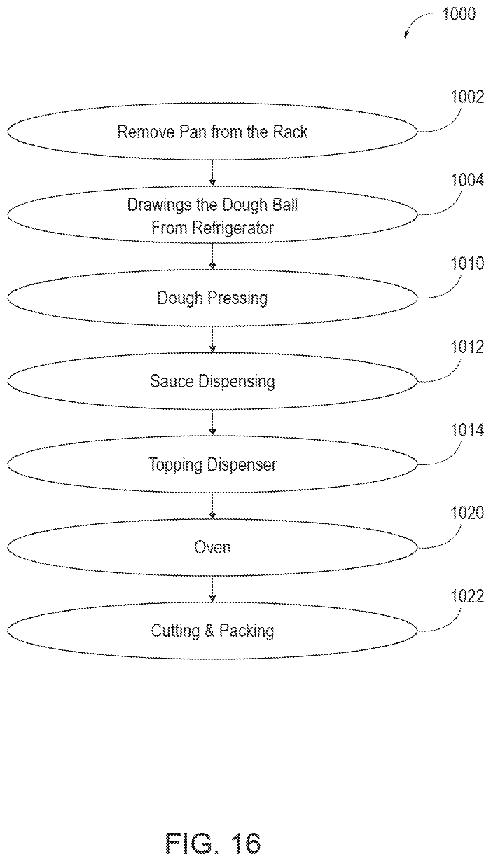

FIG. 16 depicts an exemplary pizza making method 1000 carried out by the food preparation system 100 in the kitchen 102. As depicted in FIG. 16, the pizza making method 1000 includes a first step 1002 of the control system 114 causing the transport plate 174 to be removed from the rack 240 in response to receiving a selection from a user 120 from a menu 122 via the network 1028. In particular, the selection is associated with a programmed recipe.

At a second step 1004, the method 1000 includes the control system 114 causing a drawing of the crust 204 as a dough ball from the storage container 130. For example, the control system 114 may cause the crust 204 to be provided on the transport plate 174.

At a third step 1010, the method 1000 includes the control system 114 causing the press 132 to press the crust 204 on the transport plate 174 to flatten the dough.

At a fourth step 1012, the method 1000 includes the control system 114 causing the sauce distribution device 134 to dispense sauce on the crust 204 based on the programmed recipe.

At a fifth step 1014, the method 1000 includes the control system 114 causing the toppings distribution device 140 to dispense toppings on the crust 204 in accordance with the programmed recipe. It should be appreciated that the fourth step and the fifth step above can be alternated depending on a style of pizza ordered by the customer. By way of example, for a Detroit-style pizza the toppings are typically dispensed before the sauce.

At a sixth step 1020, the method 1000 includes the control system 114 causing the oven 142 to bake the crust 204 into a pizza based on the programmed recipe.

At a seventh step 1022, the method 1000 includes the control system 114 causing the packaging station 144 cutting and packing the pizza.

FIG. 17 and the following discussion provide a description of a suitable computing environment to implement aspects of one or more of the provisions set forth herein. The operating environment of FIG. 17 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 17 illustrates a system 1100 including an apparatus 1112 configured to implement one aspect provided herein. In one configuration, the apparatus 1112 includes at least one processing unit 1116 and memory 1118. Depending on the exact configuration and type of computing device, memory 1118 may be volatile, such as RAM, non-volatile, such as ROM, flash memory, etc., or a combination of the two. This configuration is illustrated in FIG. 17 by dashed line 1114.

In other aspects, the apparatus 1112 includes additional features or functionality. For example, the apparatus 1112 may include additional storage such as removable storage or non-removable storage, including, but not limited to, magnetic storage, optical storage, etc. Such additional storage is illustrated in FIG. 17 by storage 1120. In one aspect, computer readable instructions to implement one aspect provided herein are in storage 1120. Storage 1120 may store other computer readable instructions to implement an operating system, an application program, etc. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the apparatus 1112. Any such computer storage media is part of the apparatus 1112.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The apparatus 1112 includes input device(s) 1124 such as keyboard, mouse, pen, voice input device, touch input device, infrared cameras, video input devices, or any other input device. Output device(s) 1122 such as one or more displays, speakers, printers, or any other output device may be included with the apparatus 1112. Input device(s) 1124 and output device(s) 1122 may be connected to the apparatus 1112 via a wired connection, wireless connection, or any combination thereof. In one aspect, an input device or an output device from another computing device may be used as input device(s) 1124 or output device(s) 1122 for the apparatus 1112. The apparatus 1112 may include communication connection(s) 1126 to facilitate communications with one or more other devices 1130, such as through the network 1128, for example.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Monitor,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A food preparation system arranged in a kitchen, the food preparation system comprising:
a gantry fixed with the kitchen;
at least one robot arm having an end effector supported on a base in the kitchen, wherein the base is movably mounted on the gantry, defining a reaching distance of the robot from the end effector to the base, along a travel path of the base on the gantry;
a storage container arranged in the kitchen, within the reaching distance of the at least one robot arm, and configured for storing a food item;
at least one ingredient distribution device arranged in the kitchen, within the reaching distance of the at least one robot arm, and configured for dispensing at least one ingredient on the food item; and
an oven arranged in the kitchen, within the reaching distance of the at least one robot arm, and configured for baking the food item.

2. The food preparation system of claim 1, wherein the kitchen includes a first kitchen end portion, and a second kitchen end portion extended from the first kitchen end portion in a width direction of the kitchen,
wherein the gantry includes a first gantry end portion, and a second gantry end portion extended from the first gantry end portion, toward the second kitchen end portion in the width direction of the kitchen, and
wherein the at least one ingredient distribution device is located at a side of the gantry opposite at least one of the storage container and the oven in a front-back direction of the kitchen orthogonal to the width direction of the kitchen.

3. The food preparation system of claim 2, further comprising a rack configured for storing a utensil, wherein the at least one ingredient distribution device is located at a side of the gantry opposite the storage container, the oven, and the rack in the front-back direction of the kitchen, and wherein the storage container, the oven, and the rack are arranged in that order in the width direction of the kitchen, with the storage container interposed between and separating the oven and the rack, the oven being located closer to the first gantry end portion as compared to the second gantry end portion, and the rack being located closer to the second gantry end portion as compared to the first gantry end portion.

4. The food preparation system of claim 3, further comprising:
at least one press within the reaching distance of the robot arm, wherein the at least one press is located closer to the second gantry end portion as compared to the first gantry end portion; and
a serving station including a counter within the reaching distance of the robot arm, wherein the counter is located closer to the first gantry end portion as compared to the second gantry end portion.

5. The food preparation system of claim 4, wherein the at least one press is located between at least one of the storage container, the oven, and the rack, and the at least one ingredient distribution device in the front-back direction of the kitchen, and
wherein the at least one press includes:
a first press that is an automatic press configured for actuating a first press plate toward a food item supported in the first press, wherein the first press plate is driven automatically, without manipulation of the first press by the robot arm, and
a second press that is a manual press configured for actuating a second press plate toward a food item supported in the second press, wherein the second press plate is driven manually, through manipulation of the second press by the robot arm.

6. The food preparation system of claim 4, further comprising a wall defining a closed space of the kitchen inaccessible to a user, wherein the gantry, the base, the storage container, at least one ingredient distribution device, the oven, the rack, and the at least one press are arranged in the closed space, and the counter is arranged outside the closed space, accessible to the user, wherein the robot arm is configured for delivering a food item from the closed space, through the wall, on the counter for access by the user,
wherein the counter is located between at least one of the storage container, the oven, and the rack, and the at least one ingredient distribution device in the front-back direction of the kitchen.

7. The food preparation system of claim 4, further comprising a transport plate stored in the rack, wherein the robot arm is configured for maneuvering the transport plate around the kitchen with the end effector, and the transport plate is configured for supporting a food item in the kitchen,
wherein the storage container is a refrigerator configured for storing and dispensing dough, as a food item, on the transport plate,
wherein the press is configured to press the dough on the transport plate to form a crust as a flattened dough,
wherein the at least one ingredient distribution device is a cabinet system configured to store ingredients and dispense the ingredients on the crust, the at least one ingredient distribution device including:
a first cabinet configured for storing sauce and dispensing the sauce on the crust, supported by the transport plate;
a second cabinet configured for storing cheese and dispensing the cheese on the crust, supported by the transport plate;
a third cabinet configured for storing meat and dispensing the meat on the crust, supported by the transport plate; and
a fourth cabinet configured for storing vegetables and dispensing the vegetables on the crust, supported by the transport plate, wherein the first cabinet, the second cabinet, the third cabinet, and the fourth cabinet are arranged in that order in a height direction of the kitchen orthogonal to the width direction and the front-back direction of the kitchen, and
wherein the oven is configured for baking the crust and any ingredients dispensed thereon from the at least one ingredient distribution device.

8. The food preparation system of claim 4, wherein the rack defines a rack interior configured for storing a transport plate, the rack being configured for receiving the transport plate in the rack interior through a first rack side defining the rack interior, and dispensing the transport plate from the rack interior through a second rack side opposite the first rack side and defining the rack interior, and wherein the second rack side is located closer to the gantry as compared to the first rack side.

9. The food preparation system of claim 2, further comprising a wall and a floor defining a closed space of the kitchen inaccessible to a user, wherein the gantry, the base, the storage container, the at least one ingredient distribution device, and the oven are arranged in the closed space,
wherein the gantry includes legs supported on the floor, the first gantry end portion is mounted to the wall at the first kitchen end portion, and the second gantry end portion is mounted to the wall at the second kitchen end portion.

10. The food preparation system of claim 1, wherein the storage container defines a storage container interior configured for storing the food item, the storage container being configured for receiving the food item in the storage container interior through a first storage container side defining the storage container interior, and dispensing the food item from the storage container interior through a second storage container side opposite the first storage container side and defining the storage container interior, wherein the second storage container side is located closer to the gantry as compared to the first storage container side,
wherein the at least one ingredient distribution device defines a cabinet interior configured for storing ingredients, the at least one ingredient distribution device being configured for receiving the ingredients in the cabinet interior through a first cabinet side defining the cabinet interior, and dispensing the ingredients from the cabinet interior through a second cabinet side opposite the first cabinet side and defining the cabinet interior, wherein the second cabinet side is located closer to the gantry as compared to the first cabinet side, and
wherein the oven defines an oven interior configured for baking the food item, the oven being configured for receiving the food item in the oven interior through a first oven side defining the oven interior, and dispensing the food item from the oven interior through a second oven side opposite the first oven side and defining the oven interior, wherein the second oven side is located closer to the gantry as compared to the first oven side.

11. A food preparation system arranged in a kitchen, the food preparation system comprising:
at least one robot arm having an end effector supported on a base in the kitchen, defining a reaching distance from the end effector to the base;
a storage container arranged in the kitchen, within the reaching distance of the at least one robot arm, and configured for storing a food item;
at least one ingredient distribution device arranged in the kitchen, within the reaching distance of the at least one robot arm, and configured for dispensing at least one ingredient on the food item; and
an oven arranged in the kitchen, within the reaching distance of the at least one robot arm, and configured for baking the food item.

12. The food preparation system of claim 11, wherein the food item is a dough,
wherein the food preparation system further comprises a press arranged in the kitchen, within the reaching distance of the at least one robot arm, and configured for pressing the dough to form a crust as a flattened dough,
wherein the at least one ingredient distribution device includes a sauce distribution device arranged in the kitchen, within the reaching distance of the at least one robot arm, and configured for dispensing sauce on the crust,
wherein the at least one ingredient distribution device includes a toppings distribution device arranged in the kitchen, within the reaching distance of the at least one robot arm, and configured for dispensing toppings on the crust, and
wherein the food preparation system further comprises a cutting tool arranged in the kitchen, within the reaching distance of the at least one robot arm, and configured for cutting the crust into slices.

13. The food preparation system of claim 12, wherein the storage container, the press, the sauce distribution device, the toppings distribution device, the oven, and the cutting tool are arranged in a production line with the storage container and the press located in a dough preparation area, the sauce distribution device and the toppings distribution device located in an ingredients assembly area, and the oven and the cutting tool located in a cooking area, wherein the ingredients assembly area is interposed between and separates the dough preparation area and the cooking area along the production line.

14. The food preparation system of claim 13, wherein the press, the sauce distribution device, the toppings distribution device, the oven, and the cutting tool are arranged in that order along the production line.

15. The food preparation system of claim 13, further comprising:
a transport plate configured to support the crust in the ingredients assembly area for selective application of the sauce distribution device and the toppings distribution device; and
wherein the at least one robot arm is a plurality of station arms located along the production line, each of the plurality of station arms including:
a first station arm arranged between the storage container and the press along the production line for transporting the dough from the storage container toward the press via the transport plate;
a second station arm arranged between the press and the sauce distribution device along the production line for transporting the crust from the press toward the sauce distribution device via the transport plate;
a third station arm arranged between the sauce distribution device and the toppings distribution device along the production line for transporting the crust from the sauce distribution device toward the toppings distribution device via the transport plate; and
a fourth station arm arranged between the toppings distribution device and the oven along the production line for transporting the crust from the toppings distribution device toward the oven via the transport plate.

16. The food preparation system of claim 13, wherein the at least one robot arm includes a first robot arm and a second robot arm, wherein the storage container, the press, and the sauce distribution device are arranged within a reaching distance of the first robot arm, and wherein the toppings distribution device, the sauce distribution device, the oven, and the cutting tool are arranged with a reaching distance of the second robot arm.

17. The food preparation system of claim 12, further comprising:
a wall defining a closed space of the kitchen inaccessible to a user, wherein the storage container, the press, the sauce distribution device, the toppings distribution device, the oven, and the cutting tool are arranged in the closed space, wherein the cutting tool is included in a packaging station configured to cut, package, and then dispense the crust through an opening in the wall for consumption by the user;
a user terminal arranged along the wall outside the closed space, and configured for receiving an order from the user; and
a window in the wall, the window being located between the user terminal and the packaging station along the wall, wherein the toppings distribution device is arranged at a side of the at least one robot arm opposite the window.

18. A food preparation system arranged in a kitchen, the food preparation system comprising:
a conveyor;
at least one robot arm having an end effector supported on a base in the kitchen, defining a reaching distance of the at least one robot arm;
a storage container arranged in the kitchen, configured for storing dough, and operatively connected to the conveyor for dispensing the dough onto the conveyor;
a press arranged in the kitchen, within the reaching distance of the at least one robot arm, wherein the press is configured for pressing the dough to form a crust as flattened dough, and operably connected with the conveyor for receiving the dough from the conveyor;
a sauce distribution device arranged in the kitchen, within the reaching distance of the at least one robot arm, and configured for dispensing sauce on the crust;
a toppings distribution device arranged in the kitchen, within the reaching distance of the at least one robot arm, and configured for dispensing toppings on the crust;
an oven arranged in the kitchen, within the reaching distance of the at least one robot arm, and configured for baking the crust; and
a cutting tool arranged in the kitchen, within the reaching distance of the at least one robot arm, and configured for cutting the crust,
wherein the storage container, the press, the sauce distribution device, the toppings distribution device, the oven, and the cutting tool are arranged in a production line with the storage container and the press located in a dough preparation area, the sauce distribution device and the toppings distribution device located in an ingredients assembly area, and the oven and the cutting tool located in a cooking area, wherein the ingredients assembly area is interposed between and separates the dough preparation area and the cooking area along the production line.

19. The food preparation system of claim 18, further comprising a transport plate configured to support the crust on the conveyor, and support the crust in the press, at the sauce distribution device, at the toppings distribution device, in the oven, and at the cutting tool, wherein the transport plate is secured by the end effector for being maneuvered about the kitchen by the robot arm.

20. The food preparation system of claim 18, further comprising:
a wall defining a closed space of the kitchen inaccessible to a user, wherein the storage container, the press, the sauce distribution device, the toppings distribution device, the oven, and the cutting tool are arranged in the closed space,
a packaging station including the cutting tool, wherein the packaging station is configured to cut, package, and dispense the crust through the wall, outside the closed space, for access by the user;
a user terminal arranged outside the closed space and configured for receiving an order for a food item from the user, wherein the user terminal and the packaging station are arranged along the wall; and
a window interposed between the user terminal and the packaging station along the wall, wherein the storage container, the press, the sauce distribution device, the toppings distribution device, and the oven are visible to the user from behind the window at the wall.
